(19) United States
(12) Patent Application Publication
(10) Pub. No.: US 2011/0202150 A1
(43) Pub. Date: Aug. 18, 2011

(54) Controller system adapted for SPA

(75) Inventors: Trong Huu Tran, Fountain Valley, CA (US); Howard Isham Royster, Lafayette, CA (US); Lee Lawrence West, Castaic, CA (US); Jeffrey C. Brown, Tustin, CA (US)

(73) Assignee: Newport Controls, Irvine, CA (US)

(21) Appl. No.: 12/926,215

(22) Filed: Nov. 2, 2010

Related U.S. Application Data
(63) Continuation-in-part of application No. 12/588,486, filed on Oct. 16, 2009.

(51) Int. Cl. G06F 17/00

(52) U.S. Cl. 700/90

(57) ABSTRACT

A control system adapted for spa includes a finite state machine, a control panel that includes a display, where the display of the control panel displays graphic images from a video source based on an operation of the finite state machine.

The present application is a continuation-in-part of prior application Ser. No. 12,588,486 filed Oct. 16, 2009, which is incorporated herein by reference.

### BACKGROUND

Electronic control systems have been employed to control various functions of a spa system. A controller system may include a housing structure, with a controller printed circuit board mounted with the housing and may include a heater assembly secured to a the housing structure. One problem with this configuration is that if the heating element is broken, it is very difficult to access the heating element. Sometimes during service, while replacing the heating element, the seals preventing water from entering the housing structure break resulting in the complete controller system being replaced. Also, the display technology associated with the control system is weak such that the display technology cannot handle fast moving graphic images or perform entertainment functions.

### SUMMARY

Accordingly, the present disclosure is directed to a control system that substantially obviates one or more of the problems due to limitations and disadvantages of the related control system.

Additional features and advantages will be set forth in the description which follows, and in part will be apparent from the description, or may be learned by practice of the invention. The objectives and other advantages will be realized and attained by the structure particularly pointed out in the written description and claims hereof as well as the appended drawings.

To achieve these and other advantages a control system adapted for spa includes a finite state machine, a control panel that includes a display, where the display of the control panel displays graphic images based on an operation of the finite state machine.

It is to be understood that both the foregoing general description and the following detailed description are exemplary and explanatory and are intended to provide further explanation of the invention as claimed.

### BRIEF DESCRIPTION OF THE DRAWINGS

The patent application file contains at least one drawing executed in color. Copies of this patent application publication with color drawings will be provided by the Office upon request and payment of the necessary fee.

The accompanying drawings, which are included to provide a further understanding of the invention and are incorporated in and constitute a part of this specification, illustrate embodiments of the invention and together with the description serve to explain various principles.

In the drawings:

FIG. 1 illustrates an overall block diagram of an exemplary spa system.

FIG. 2 illustrates a block diagram of an exemplary control system of the spa system.

FIG. 3 illustrates an exemplary controller;

FIG. 4 illustrates another exemplary controller;

FIGS. 5-14 illustrate an exemplary display panel.

FIGS. 15-21 illustrates an exemplary control system package that contains an exemplary control system and an exemplary heater assembly.

FIGS. 21-50 illustrate menus for controlling the spa system components using the display panel.

FIG. 51 illustrate another exemplary display panel.

### DETAILED DESCRIPTION OF THE ILLUSTRATED EMBODIMENTS

Reference will now be made in detail to the embodiments of the present invention, which are illustrated in the accompanying drawings.

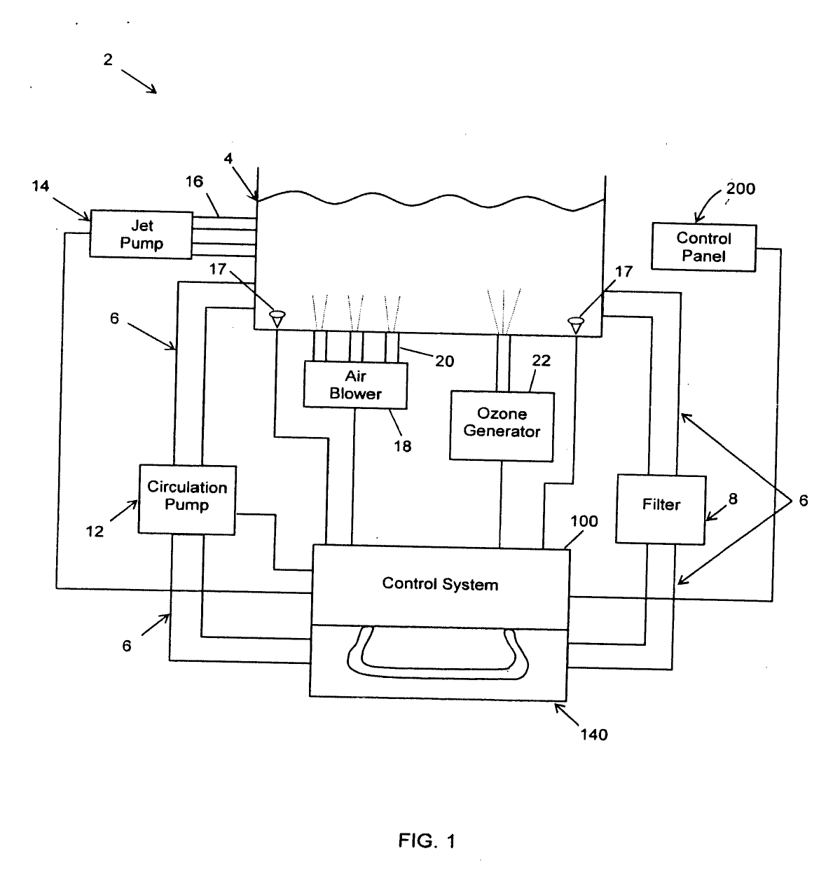

FIG. 1 illustrates an overall block diagram of an exemplary spa system 2. The spa system 2 includes a vessel 4 for holding a volume of water. Pipes 6 couple one end of a filter 8 to the vessel 4 and another end of the filter 8 to an end of a heater assembly 140. The pipes 6 further couple another end of the heater assembly 140 to an end of a circulation pump 12 and couple another end of the circulation pump 12 to the vessel 4. When operational, the circulation pump 12 pumps the water held in the vessel 4 through the filter 8 and the heater assembly 140 and back to the vessel 4 through the pipes 6. The filter 8 removes particulates from the vessel water as it passes through the filter 8. If operational, the heater assembly 140 heats the vessel water passing through the heater assembly 140. Also a jet pump 14 is coupled to the vessel 4 through pipes 16. When operational, the jet pump 14 draws water from the vessel 4 and outputs the water back into the vessel in a form a high pressure jet stream.

An air blower 18 is also coupled to the vessel 4 for blowing bubbles into the vessel through air pipes 20. An ozone generator 22 may be coupled to the vessel 4 to deliver ozone into the water held by the vessel 4 in order to exterminate and sanitize the water from bacteria. Lighting 17 is also provided for illumination of the water at night and may be colored in order to create moods.

In the exemplary spa system 2, a control system 100 includes the heater assembly 140. The control system 100 manages various parameters of the spa system 2 and with the heater assembly 140, manages the temperature of the water held in the vessel 4.

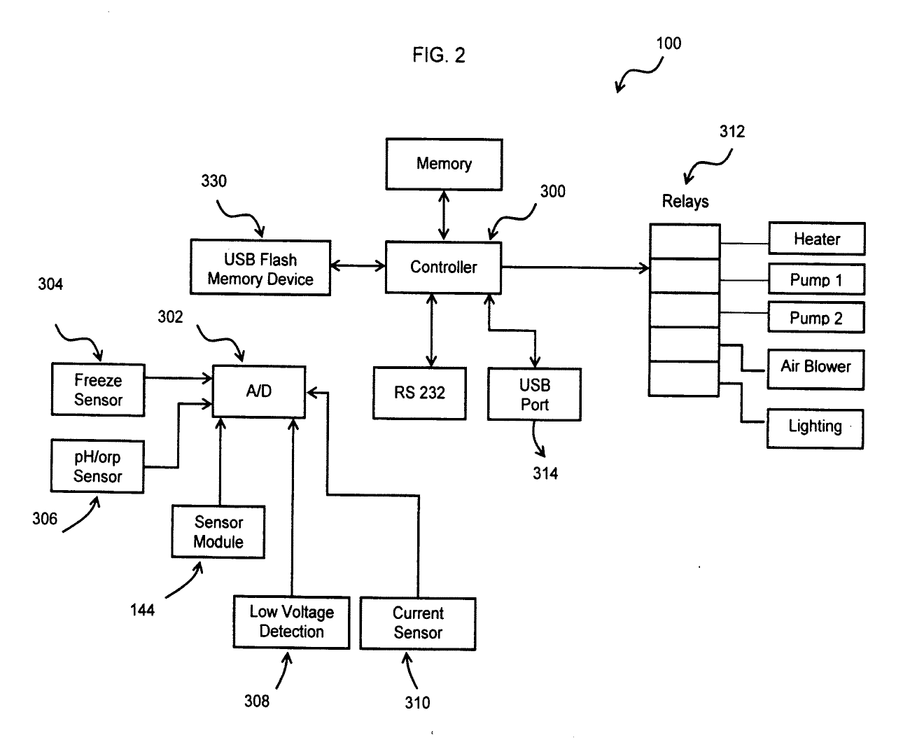

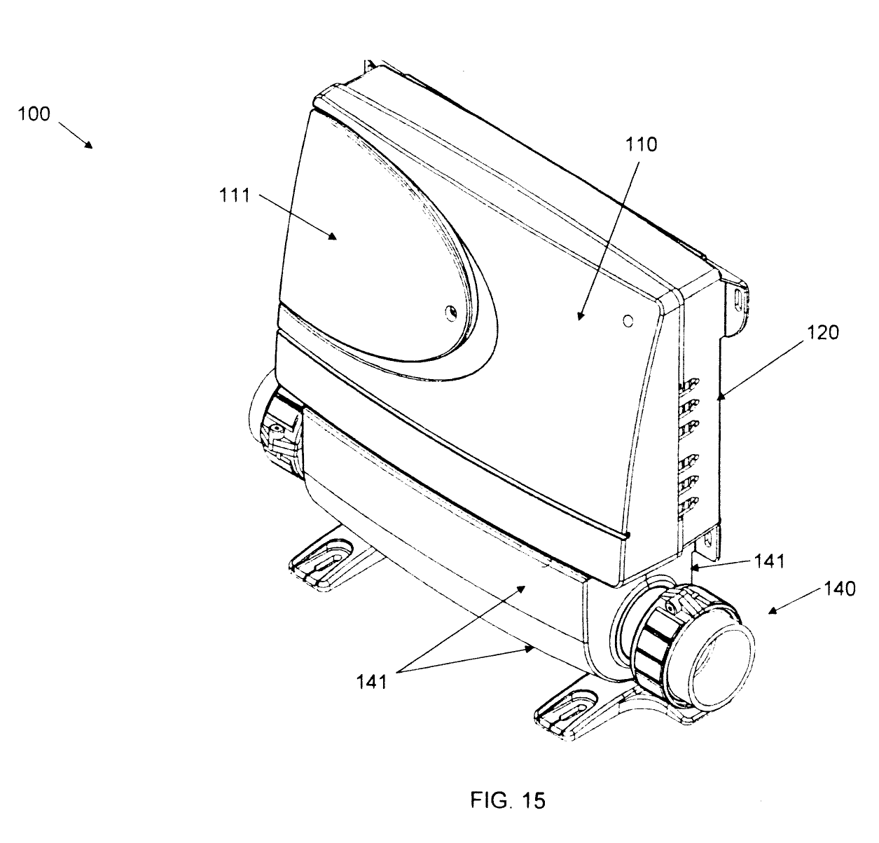

FIG. 2 illustrates a block diagram of an exemplary control system 100 of the spa system 2. The control system 100 includes a controller 300 where various sensors are coupled to the controller 300. If a sensor outputs a digital signal, the sensor can be directly coupled to the controller. Otherwise, if a sensor outputs an analog signal, the sensor is coupled to the controller through an analog/digital (A/D) converter 302. A/D converters are well-known devices and will not be further discussed. In this instance, the control system 100 uses a freeze sensor 304 to determine whether water in a water conduit (see FIG. 15 element 141) containing the heating element is freezing; a pH/oxidation-reduction potential (ORP) sensor 306 to sense a chemical balance of the water in the vessel of the spa system, a temperature sensor module 144 to determine the temperature of the water in the water conduit where the heating element is housed.

The control system 100 can include a low voltage detection sensor 308, perhaps, located at the power input of the spa system, to determine irregularities in the voltage level. For instance, a voltage measurement lower than a predetermined voltage level or an erratic fluctuation in the voltage may indicate that the control system 100 is not functioning properly, and thereby warranting a service or a shut-down of the control system 100. Generally, any detected voltage irregularities is recorded in an event log, which is stored in a memory that is preferably a non-volatile memory, such as a USB flash memory device 330.

The control system can further include a current sensor 310, perhaps, located at the power input of the spa system 2, to sense current consumption of the spa system 2. In this instance, the major power consumption devices can be the circulation pump, the jet pump, the air-blower, and the heater. While the electric circuit capacity of the spa system 2 may be fully capable of handling the simultaneous operation of all power consumption devices in the spa system 2, the possibility is that such operation may overload the house or structure in which the spa system 2 is situated resulting in the house or the structure's circuit breaker to trip.

In any event, the exemplary control system 100 has its heating element coupled to a relay 312 that is controlled by the controller 300. A control system of another embodiment may further have the air blower or lighting system coupled to a respective relay and controlled by the controller. The determination of which devices are to be controlled by the controller 300 through a relay 312, perhaps, may be a design choice or may be based on manufacturing specifications. One or more, if not all of the relays 312 under the control of the controller 300 are capable of switching between a 120V power supply and a 240V power supply supplied from a power supply of the spa system 2. An exemplary operation of the relays under the control of the controller will now be described.

The determination of when the heating element will have its power consumption reduced or switched off based on operation parameters and power consumption may be done by the manufacturer or vendor, and/or the user. For instance, in the case of the manufacturer, the control algorithm may be pre-installed in a non-volatile memory, preferable a USB flash memory device, at the control system 100. In the case of the vendor or the user, the control panel 200 (see FIG. 1) may be used to input the operation parameters of the devices. Details of the control panel will be discussed with further below and will not be further discussed here.

Suppose the circulation pump operates at 10 A, the jet pump operates at 10 A, the air-blower operates at 10 A, and the heater operates at 20 A but can operate at reduced capacity at 10 A. Suppose the spa system is specified to operate at maximum of 40 A consumption. If the user operates all the above devices simultaneously, the total consumption will be 50 A, which is beyond the operation parameter of 40 A. The current sensor 310 that may be continuously sensing and sending the power consumption of the spa system 2 will forward this consumption information, that is, that the spa system is operating at 50 A power consumption to the controller 300. The controller 300 determining that the spa system 2 is operating beyond the operation parameter sends a signal to the relay 312 coupled to the heating element based on the control parameters previously determined.

For example, the control parameters may dictate that in the above situation the heating element should be switched off, in which case, the controller 300 may send a signal to the relay 312 coupled to the heating element to switch off the power supply to the heating element. The controller 300 may also send a signal to the control panel 200 to display that the heating element has been turn off because the operation parameter has been exceeded. In another aspect, the control parameters may dictate that in the above situation the heating element should be operated at 10 A instead of 20 A. In this case, the controller 300 may send a signal to the relay 312 coupled to the heating element to switch from 240V to 120V, in which case the heating element is supplied with 10 A, thereby allowing the spa system 2 to operate in the operating parameter. Various control operations may be determined based on design choice and/or user selection.

In another aspect, the circulation pump, the jet pump, the air-blower, and the heating element each are coupled to a relay 312 that is controlled by the controller 300. A control system of another embodiment may further have the ozone generator, lighting, and other pumps in the spa system coupled to a respective relay. The determination of which devices are to be controlled by the controller through a relay, perhaps, may be a design choice or may be based on manufacturing specifications. One or more, if not all of the relays under the control of the controller are capable of switching between a 120V power supply and a 240V power supply supplied from a power supply of the spa system. An exemplary operation of the relays under the control of the controller will now be described. A manufacturer or vendor may have an assortment of pumps and other devices that operate on 240V or 120V. Previously, the controller system had to be hand set to accommodate the various devices having either 240V or 120V. In this instance, the voltage requirements of each device is stored in a memory of the control system. The control system knowing the voltage requirements of each device will send a signal to the respective relays to switch between 240V or 120V to meet the voltage requirements of the respective device.

The control system 100 may also have a serial and/or parallel input and/or output port for communicating with the outside environment. As an example, the serial or parallel port may provide for Internet communication channel with the control system 100. The control system 100 may also have a USB port 314 and/or wireless communication interface (not shown). As an example, the USB port 314 and/or wireless communication interface may allow for a diagnostic device to have access to the control system 100 in order to obtain information, for example, regarding operations or cause of malfunctions of the control system, or simply perform diagnostic routines on the control system 100. It should emphasized that the usage of the ports is not limited to those described above. As an example, the ports could be used to couple audio and/or video devices to the control system 100 so as to enhance the spa experience with various entertainment devices as seen fit by the manufacturer, the vendor, or the user.

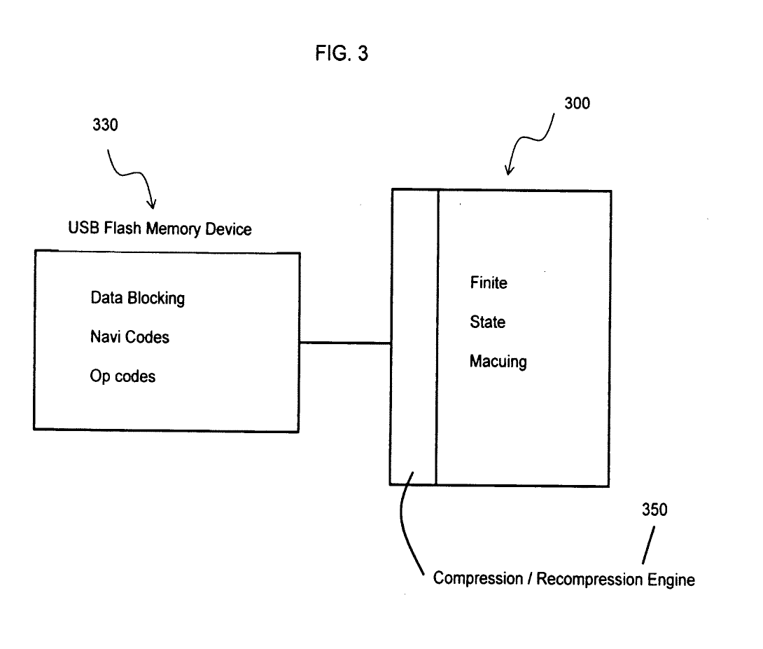

Referring now to FIG. 3, the controller 300 may formed in a field programmable gate array (FPGA). However, the controller 300 can be formed using application specific integrated circuits (ASICs), complex programmable logic devices (CPLDs) or other suitable integrated circuit devices. In this instance, an FPGA available from Xilinx® Inc., located in San Jose, Calif., USA, is used. For example, the FPGA may be the Spartan® series.

The controller 300 is a finite state machine that transitions to a state in a finite number of states where each transition occurs due to a triggering event. Simply put, the finite state machine is driven by events. For instance, an event may be triggered by an input signal from a user through the control buttons located at the control panel. Events may be triggered by periodic time signals where each event is triggered by each time signal sent by a clock included in the control system that represents time of day. An event may be triggered by a signal sent at a predetermined time based on a programmed event, for example, a “wake-up” signal to cause the control system to wake-up from dormancy in order to circulate water in the spa system, for example. Each event causes finite state machine to transition from a current state to another state, or in some cases, the finite state machine does not transition to another state but returns to the current state. There are many action types in the finite state machine such as “entry action” where an action is performed when entering a state; and “exit action” where an action is performed when exiting a state. Usually, the finite state machine described above performs entry action. However, the finite state machine need not be limited to this type of action.

In the present embodiment, any one or more of blocks of data that represent text and/or graphic image, navigational data block, and opcode sequences that are arranged to produce executable binary codes constitute an action that can be triggered by an event. The data blocks could be graphical and text images. The navigational data block could be pointers to a background layer, foreground layer, and/or sprites layer (these layers will be discussed below). Also, the navigation data block could be pointers to the next state. The navigation data block could be a pointer to a sequence of opcodes or a pointer to a register value that could be a link to the opcodes. In other words, the navigation data block is used to find various data in a memory and/or provide pointers to the next state, for example. Since the finite state machine is a structure composed of a finite number of states to transition between, the characteristics of the controller is defined by the blocks of data that represents text and/or graphic image, navigational data block, and opcode sequences, which in this embodiment, are stored in a USB flash memory device such as a memory stick that couples to the controller through a USB port.

It should be noted that other information such as Infrared (IR) codes for various electronic devices can also be stored in the USB flash memory device. The concept is similar to the universal remote device. The control panel can be provided with an IR transmitter, which allows the control panel to operate as a remote for various electronic devices, such as audio and video devices, and well as operate various motors, for example, to lift up an LCD TV monitor above the spa system or lift down the LCD TV monitor in order to hide the monitor.

Depending on the amount of data, navigation data, and opcodes that need to be stored in the USB flash memory device, the controller may further include a decompression engine 350 with an presumption that the data and the opcodes are compressed prior to being stored in the USB flash memory device. Thus, when an action is retrieved from the flash memory device, prior to being acted on, the action is first decompressed by the decompression engine 350 and then executed. The decompression engine 350 can be formed with the finite state machine in the FPGA and can adopt any one of the well-known data decompression algorithms. As discussed above, certain irregularities in the operation of the spa system may cause the control system to log those irregularities in an event log that is stored in the USB flash memory device, for example. In order to conserve memory space in the USB flash memory device, the controller may further include a compression engine 350 to compress data representing the irregularities that occurred during operation. The compression engine 350 can be also formed in the FPGA and can adopt any one of the well-known data compression algorithms.

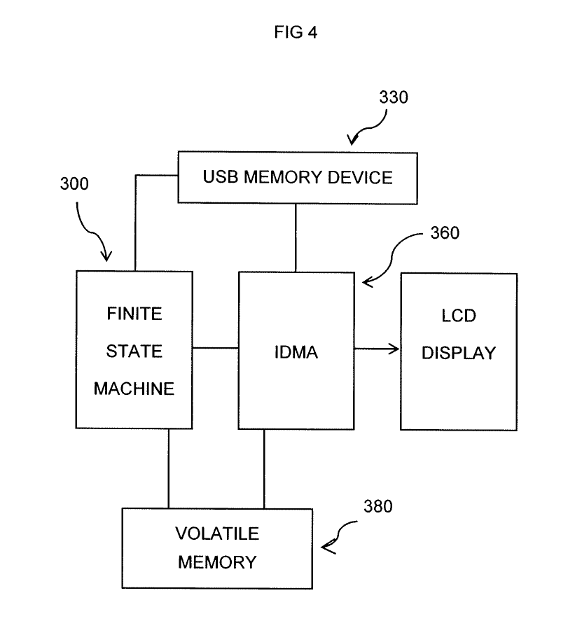

Certain applications performed by the control system may require fast moving graphic images. For example, the applications may involve commercials or information regarding the manufacturer's or vendor's other products. In these instances, the controller 300 may include a graphics engine to accommodate fast moving graphic images. In this embodiment, as shown in FIG. 4, the graphics engine may be formed using an intelligent direct memory access (IDMA) controller 360. The IDMA controller 360 is imparted with operation parameters such as source address, destination address, transfer length, and transparency bit, which can be stored in its registers. The IDMA controller 360 can be dynamically provided with these operation parameters when an operation of the IDMA controller 360 is required from the volatile memory which was previously received from the USB flash memory device 330. For instance, an action during transition in the finite state machine may include a pointer to the operation parameters and requesting the IDMA controller 360 to begin loading the operation parameters. Once loaded with the operation parameters, the IDMA controller 360 can transfer graphic data from source to destination as dictated by the operation parameters. In this instance, the source of the graphic data is the compressed imagery in the portion of the volatile memory previously received from the USB flash memory device and the destination is another portion of the same volatile memory, where a portion of that memory has been reserved for video (e.g., frame buffer). The IDMA controller 360 then transfers the graphic data to the LCD display module using a serial communication protocol.

An aspect of the IDMA controller 360 is that the controller includes a data intelligence unit that can process and manipulate data received by the IDMA controller 360. Using this feature, for instance, a separate compression/decompression engine may not be necessary since the IDMA controller 360 can compress or decompress graphic data during transfer by processing the opcodes that provides for compressing or decompressing data. The data manipulation feature of the IDMA controller 360 has particular usage in generating graphic images and is beneficial in processing fast moving graphic images.

For instance, a single graphic image may be created using multiple layers comprising a background layer, one or more foreground layers, and one or more “sprites” layer. Here, a “sprites” refers to an small image (an object) that can be integrated into a larger image. As an example, the background layer may be the blue background. The one or more foreground layers may contain the graphics and text. The sprite layer may include objects that frequently changes or is short lived. In overlaying the sprites layers and the foreground layers to the background layer, transparency is important. Transparency allows overlayed layers to blend with the image of the layer below. The transparency bit in conjunction with the data intelligence unit processing the transparency bit can provide the IDMA controller with the capability of transparency. Thus, by using multilayers to form a graphic image and transparency, the IDMA controller need not refresh all the pixels comprising the complete graphic image but rather the IDMA controller only changes those pixels in which that portion of the graphic image has changed.

A controller using a finite state machine and IDMA controller has uses other than the spa system environment. The controller has uses in display technology that can be used in avionics, automotive, and other areas where display technology may be required.

FIGS. 5-14 illustrate an exemplary display panel 200.

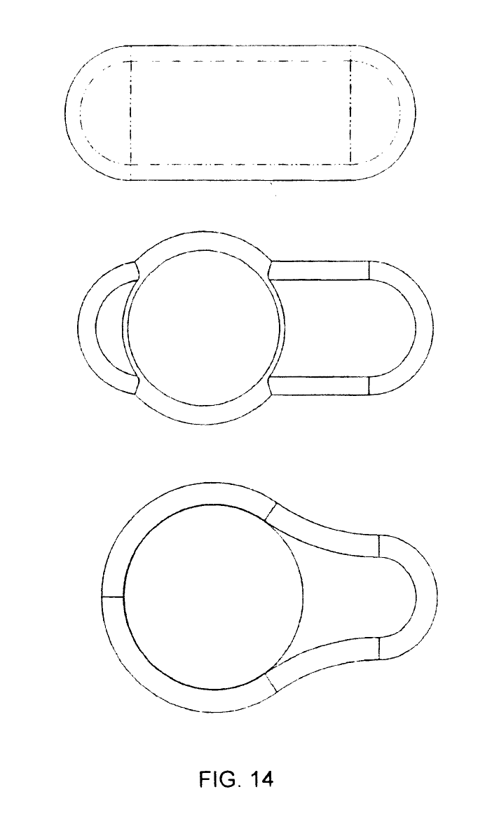

As shown in FIG. 5, the display panel 200 includes a display region 201 for displaying information for viewing and an interface region 202 for receiving selections from a user. A color liquid crystal display (LCD) may be used as a display which may be controlled by an LCD controller. However, other suitable displays and controllers may be used. As shown in FIG. 14, the display panel may having different shapes. In one embodiment, the display region 201 may also acts as an interface region 202, such as when the display region 201 is a touchscreen display.

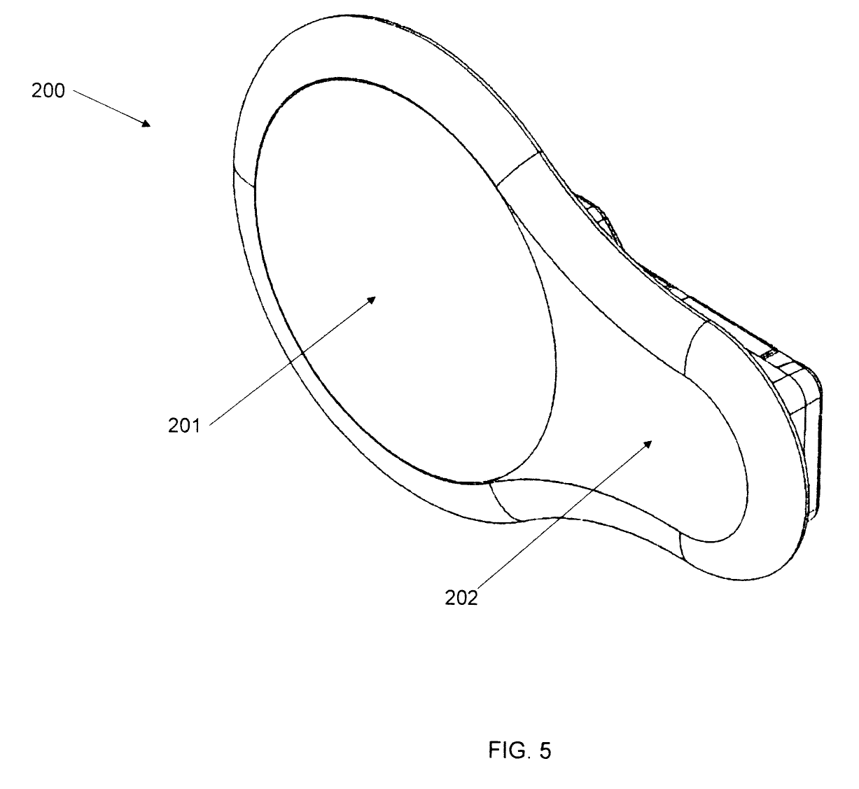

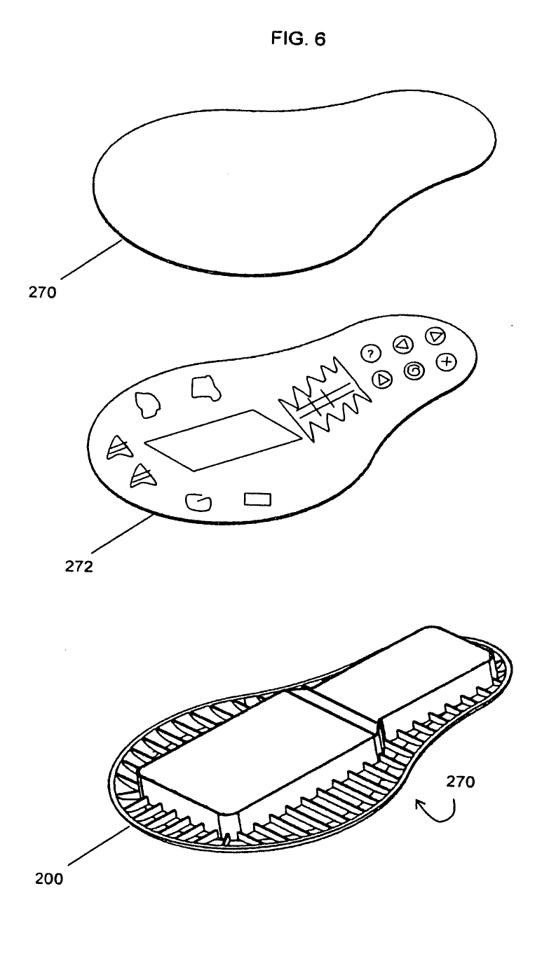

As shown in FIG. 6, an outer shell 270 of the display panel 200 is made of transparent plastic. A graphic design 272 or simulation according to design specification is printed or silk screened into the inner surface of the outer shell 270 of the display panel 200. Then the remaining plastic parts of the display panel are injection molded onto the inner surface of the outer shell of the display panel resulting in the display panel 200 shown at the bottom of FIG. 6. The advantage of this feature is that the graphic design or simulation is protected by the outer surface of the outer shell of the display panel. Also, capsense™ switches provided at the display panel are also protected. Secondly, the single piece outer shell of the display panel provides for a waterproof surface in that there is no breaks in the surface in which water may leak through.

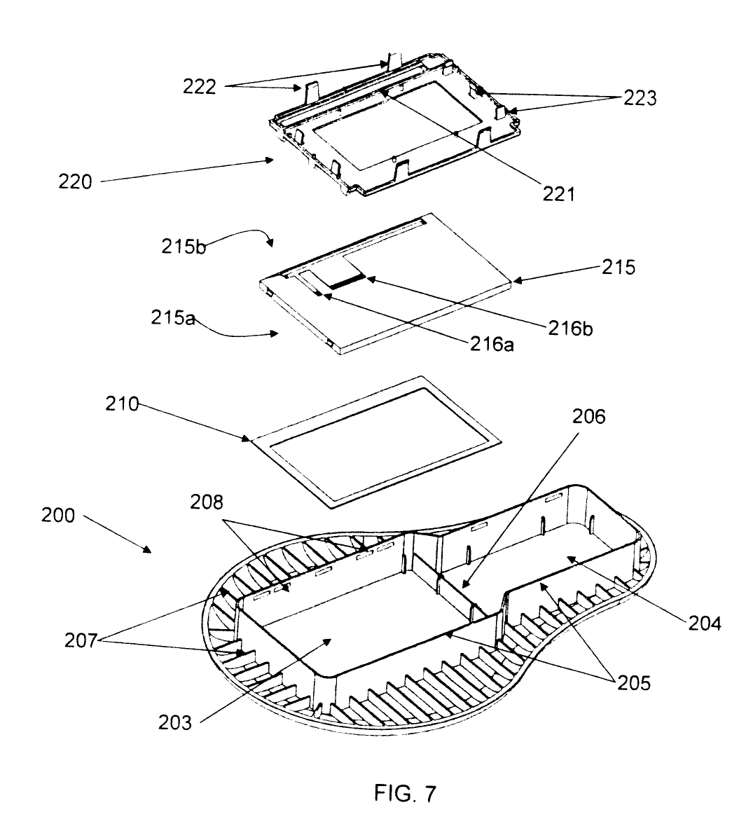

FIG. 7 illustrates a step of assembling a display panel. The back side of the display panel 200 includes a display housing 203 and interface housing 204. The bottom of the display housing 203 is transparent for allowing display information to be shown to the user through the top surface of the display region 201 of the display panel 200. The bottom of the interface housing may be transparent or translucent for allowing light to illuminate buttons or decorative features on the top surface of the interface region 202 of the display panel 200. The bottom of the interface housing includes a communication connection 204c for communicating between the buttons, for example, in the interface region 202 of the display panel 200 and the circuits of the display panel 200.

The display housing 203 and interface housing 204 are surrounded by perimeter walls 205 sealing the display housing 203 and interface housing 204 from the outside of the display panel 200. A separation wall 206 separates the display housing 203 from the interface housing 204. Reinforcement ribs 207 extend between the separation wall 206 along to the underside of the display panel 200 to the periphery of the display panel 200.

FIG. 7 also illustrates a display gasket 210, a display 215 for displaying information to the user and a display retainer 220. The display gasket 210 may have a paper liner on one or both sides prior to assembly. The display 215 includes a display side 215a and a back side 215b and includes flexible cables 216a and 216b. The display retainer 220 includes one or more rectangular cutouts 221 for passing through the flexible cables 216a and 216b of the display 215 and includes one or more snap features 222 for securing the display retainer 220 to the display panel 200 and one or more mounting ribs 223 for holding a PCBA thereon.

During assembly, the paper liner of the display gasket 210 is removed from side facing the display 215 and the display gasket 210 is fixed to the display side 215a of the display 215. The paper line is removed from the side facing the display panel 200 and the display gasket 210/display 215 assembly is fixed to the display panel 200. Adhesive, such as hot glue, may be provided around the perimeter of the display gasket 210/display 215 assembly to secure the assembly to the display panel 200.

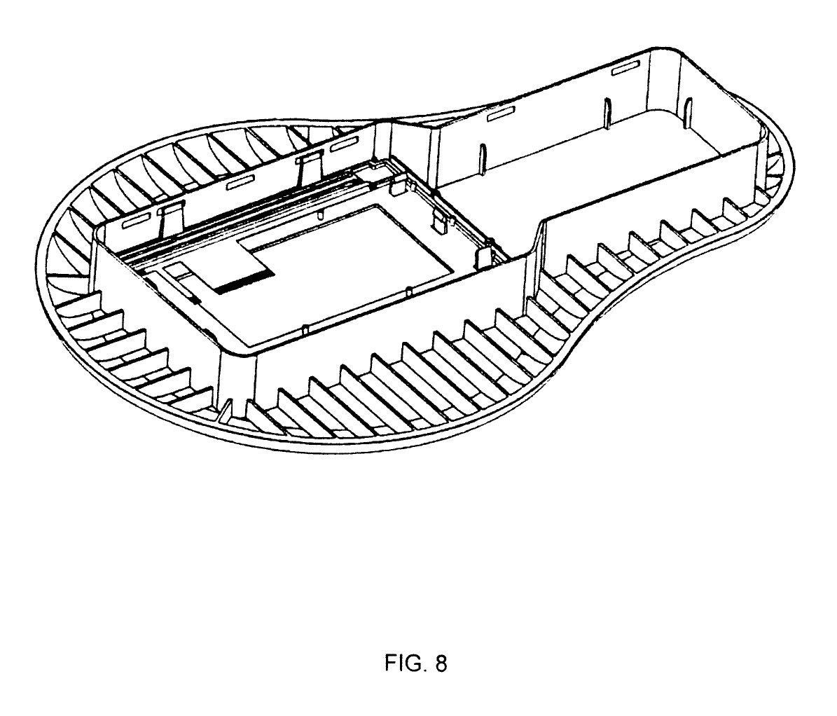

The display retainer 220 is installed on the back side 215b of the display while slipping the flexible cables 216a and 216b through the one or more rectangular cutouts 221 of the display retainer 220. Then, the display retainer 220 may be snapped into place by snapping the snap features 222 of the display retainer into retainer installation cutouts 208 of the display panel 200. FIG. 8 illustrates the display panel 200 with the display gasket 210, the display 215 and the display retainer 220 assembled therein as described above with reference to FIG. 7.

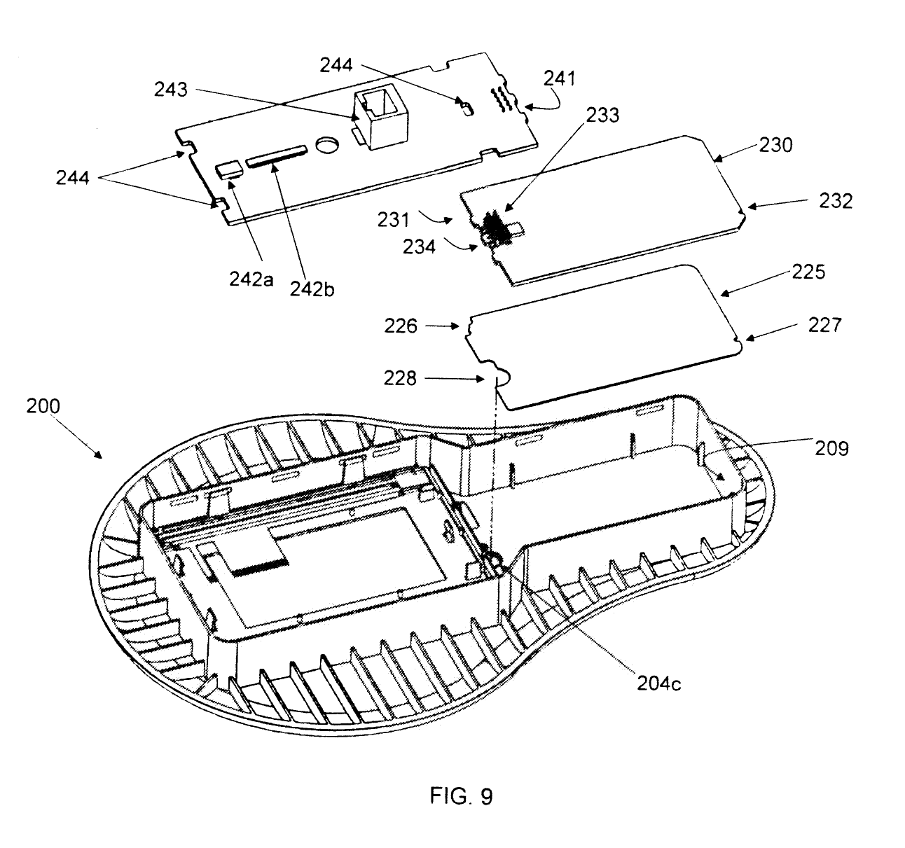

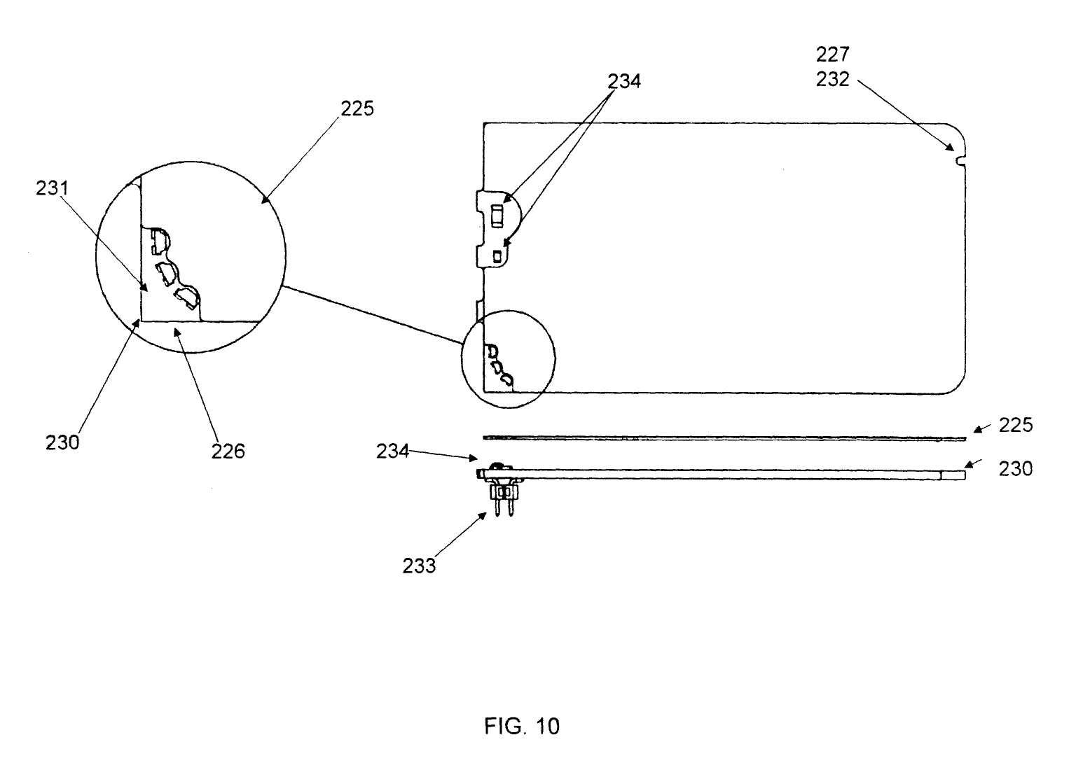

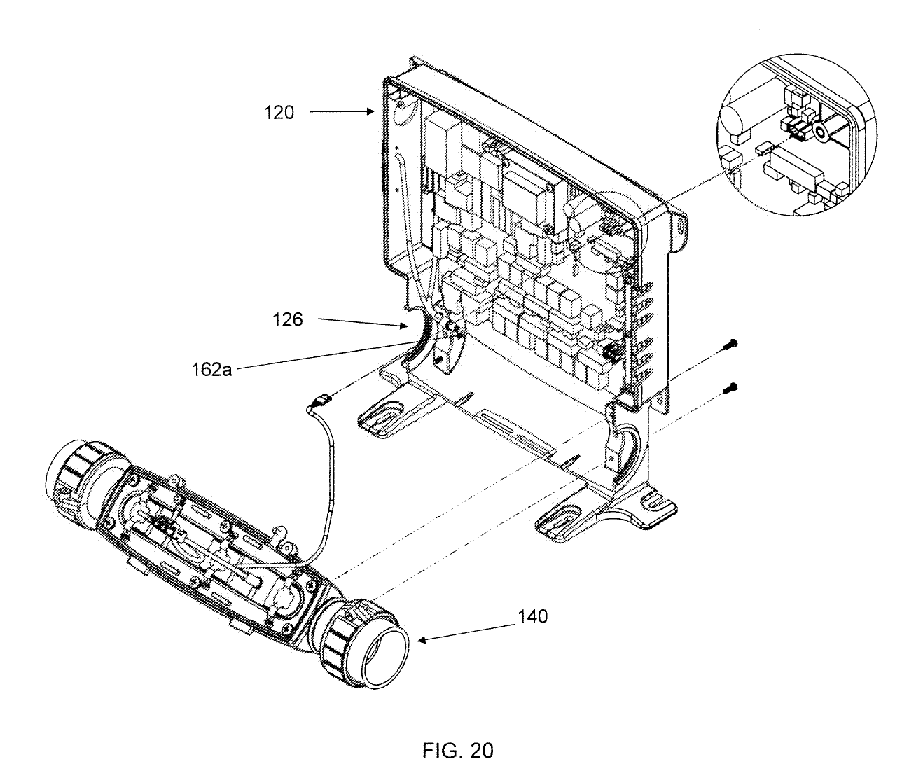

FIGS. 9 and 10 illustrate the display panel 200 of FIG. 20 and further illustrates a lightpipe 225, a first PCBA 230 and a second PCBA 240. The lightpipe 225 includes a first and second cutout regions 226 and 228. First cutout region 226 corresponds to an LED region 231 on the underside of the first PCBA 230, and second cutout region 228 corresponds to a communication pathway between the first PCBA 230 and the communication interface 204c of the interface housing 204c. The lightpipe 225 guides light from the LEDs of the LED region 231 to the bottom of the interface housing 204, thereby illuminating buttons or decorative features on the top surface of the interface region 202 of the display panel 200. Both the lightpipe 225 and the first PCBA 230 include alignment notches 227 and 232 corresponding to an alignment rib 209 extending from the perimeter wall 205 of the interface housing 204. The first PCBA 230 further includes an upper connector 233 on a top surface for communicating with the second PCBA 240 and a lower connector 234 for communicating with the interface region 201 via the communication connection 204c. The second PCBA 240 includes a lower connector 241, flex cable connectors 242a and 242b, external cable connector 243 and mounting rib slots 244.

It should be noted that the above control panel contemplates a wired communication with the control system 100. However, by providing wireless capability to the control panel, the control panel can wirelessly communicate with the control system 100 and the external cable connector 243 is not necessary. Any wireless technology, such as bluetooth® technology may be used to provide wireless communication between the control system and the control panel.

The lower connector 241 is on a lower surface of the second PCBA 240 and communicates with the upper connector 233 of the first PCBA 230. The flex cable connectors 242a and 242b communicate with the flexible cables 216a and 216b of the display 215, the external cable connector 243 connects with an external cable for communicating with the control panel assembly 100, and the mounting ribs slots 244 retain the mounting ribs 223 of the display retainer 220. In an alternative embodiment, the display panel 200 wirelessly communicates with the control panel assembly 100 and the external cable connector 243 is not present in the display panel 200.

During assembly, a paper liner on the lightpipe 225 if present is removed to expose an adhesive upper surface. The lightpipe 225 is aligned to the LEDs on the first PCBA 230 and attached to the first PCBA 230. In alternative embodiments, the adhesive backing may be disposed on the bottom surface of the first PCBA, an adhesive may be provided between the lightpipe 225 and the first PCBA 230 or no adhesive may be present between the lightpipe 225 and the first PCBA 230.

A paper liner on the lower surface of the lightpipe 225 if present is removed and the lightpipe 225/first PCBA 230 assembly is installed to the display panel 200, making sure the notches 227 and 232 are aligned to the alignment rib 209 of the display panel 200. As such, the lower connector (not shown) of the first PCBA 230 connects with the communication connector 204c of the interface housing 204.

The second PCBA 240 is installed the display panel 200 by aligning the upper connector 233 of the first PCBA 230 with the lower connector 241 of the second PCBA 240. Also, the mounting ribs 223 of the display retainer 220 are snapped into the mounting rib slots 244 to hold the second PCBA 240 in place. Furthermore, the flexible cables 216a and 216b of the display 215 are connected with the flex cable connectors 242a and 242b of the second PCBA 240.

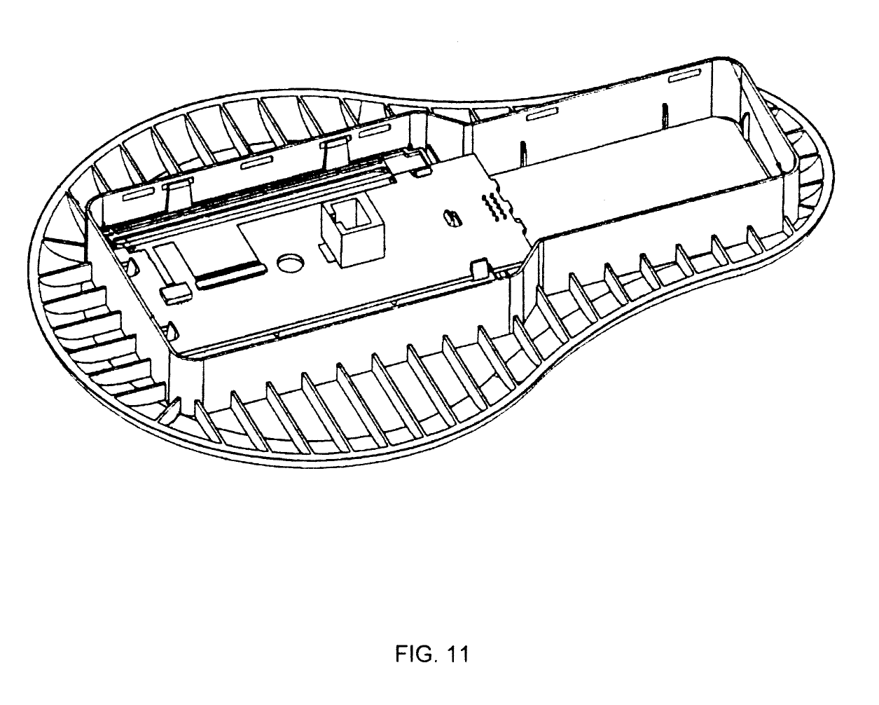

FIG. 11 illustrates the display panel 200 with the display lightpipe 225, the first PCBA 230 and the second PCBA 240 assembled therein as described above with reference to FIGS. 9 and 10.

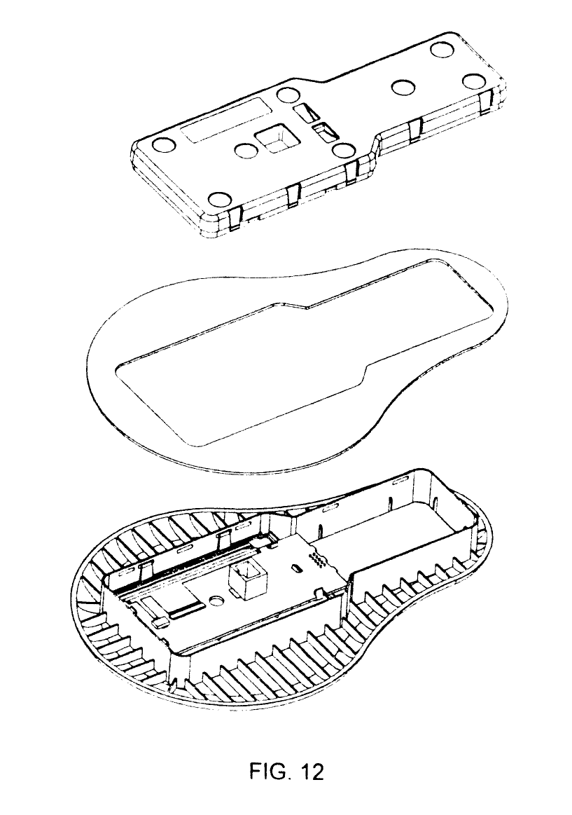

FIG. 12 illustrates the display panel 200 of FIG. 11 and further illustrates a panel gasket 250 and a rear cover 260. During assembly, the rear cover 260 snaps into the display panel 200 and the panel gasket 250 is installed around the rear cover 260.

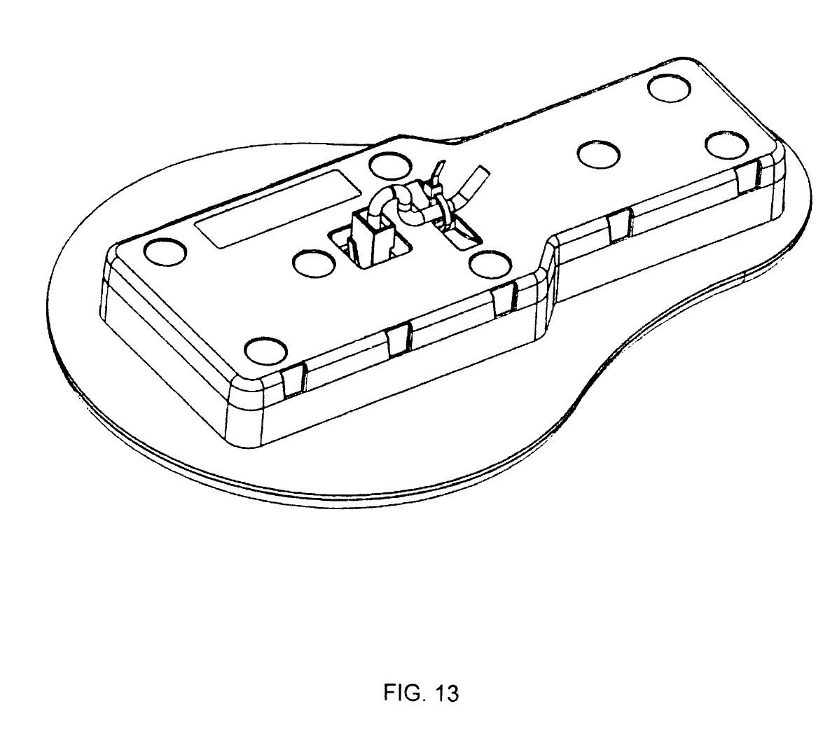

FIG. 13 illustrates the display panel 200 with the panel gasket 250 and the rear cover 260 assembled therein as described above with reference to FIG. 12. Furthermore, FIG. 13 illustrates an external cable connected through the rear cover 260 to the external cable connector 243 of the second PCBA 240.

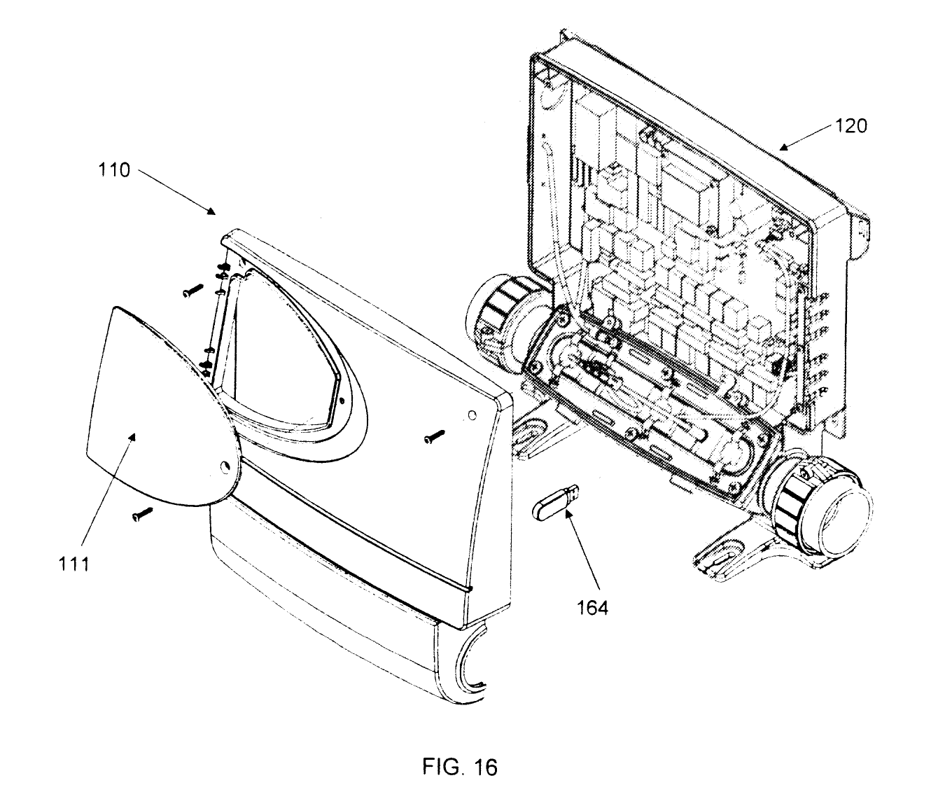

FIGS. 15-24 illustrates an exemplary control system package that contains the control system and an exemplary heater assembly. As shown in FIG. 15, the control system package 110 includes a cover 120 and an enclosure base 130, both of which may be formed of plastic. As shown in FIG. 16, the cover 120 includes a removable door 121 for easy access to terminal and fuses of the control system 100. Thus, this feature, for example, allows for a user to easily access and replace the fuses without having access to other parts of the control system 100, which are more suitable for a technician should maintenance or repair be required. FIG. 16 shows a USB flash memory device that is not accessible unless a cover 120 is removed. As described above, the USB flash memory device may contain blocks of data, navigational data block and opcode sequences. It may be that the design specification does not want a user to have access to the USB flash memory device but only a technician. However, should the design specification permit user access, the USB flash memory device can be located in the vicinity where opening the removable door 121 provides access to the USB flash memory device.

Further shown in FIG. 16, a lower portion of the control system package 110 contains the heater assembly 140 for heating water passing therethrough. The heater assembly 140 includes a trough-shaped conduit 141 with open ends at either end of the conduit 141 for passing water therethrough. A heater element (not shown) is housed within the conduit 141 for heating the water passing through the conduit. A sensor module 142 covers the open portion of the trough-shaped conduit 141 and is held in place fasteners such as six screws.

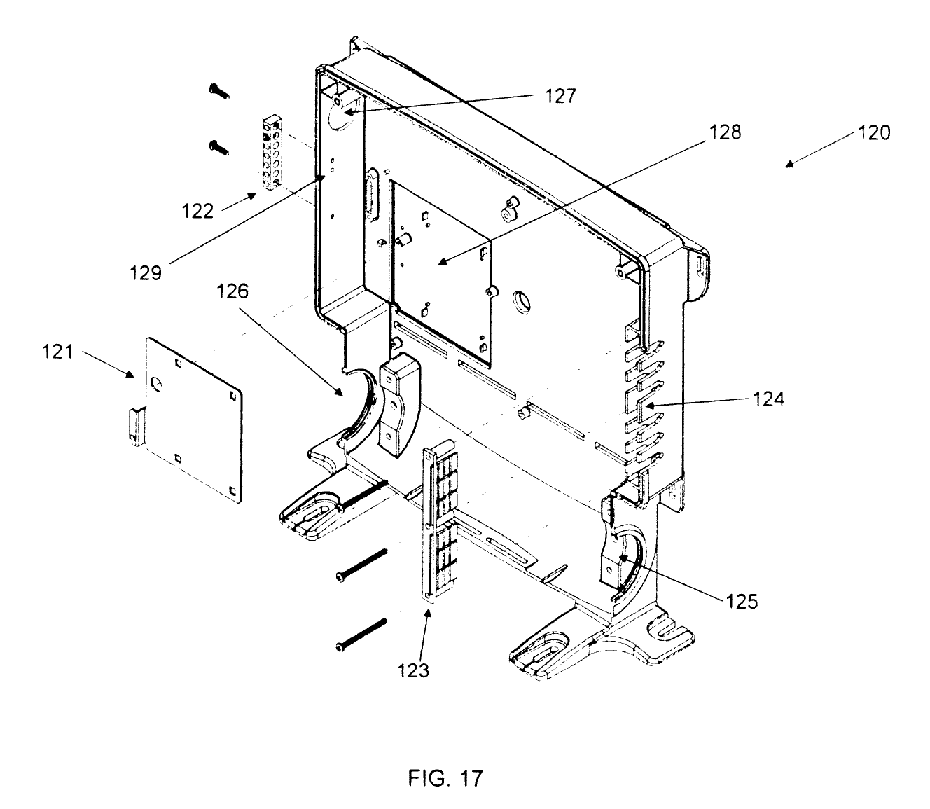

FIG. 17 illustrates steps of assembling an exemplary control system package. A heatsink plate 121 is placed to a heatsink holder 128 of the enclosure base 120, a neutral bar 122 is installed at an outer surface of the enclosure base 120 adjacent a ground wire connection hole 129, and a cable clamp 123 is installed in a cable clamp holder 124 of the enclosure base 120. The enclosure base 120 includes retaining arms 125 for retaining the heater sub-assembly 140 in the control system assembly 100 and heater access openings 126 for allowing water to pass through the heater sub-assembly 140 within the control system assembly 100. The enclosure base 120 further includes a wiring access opening 127 for allowing external wiring to pass therethrough to a terminal of the control system assembly 100.

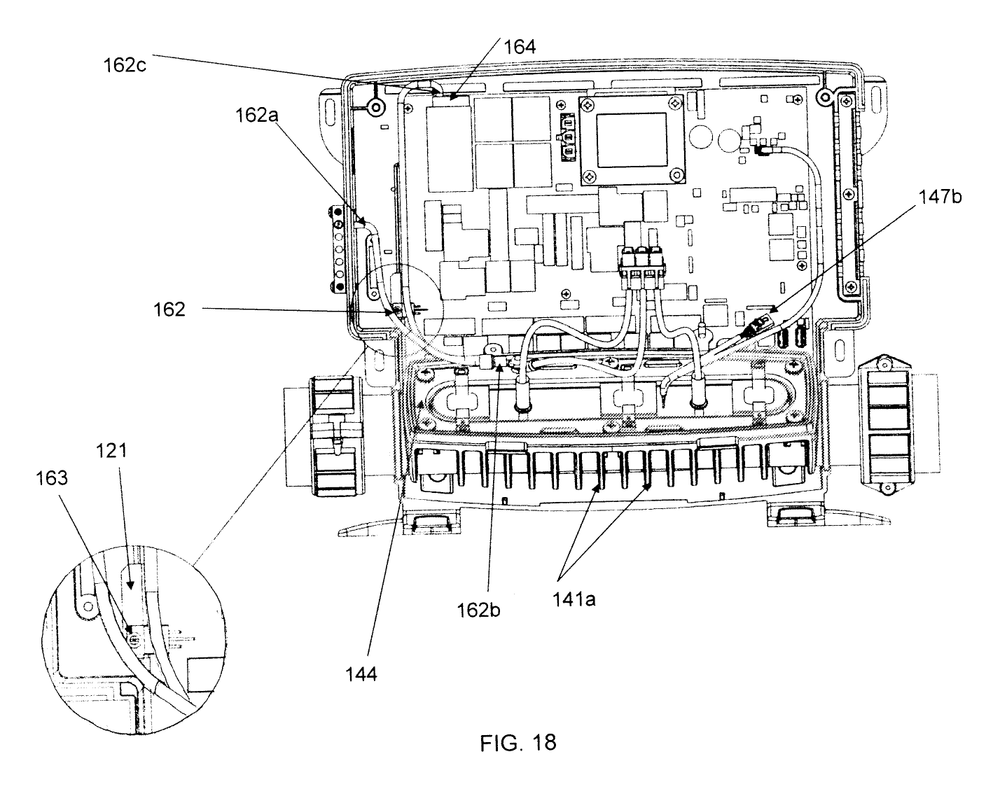

FIG. 18 illustrates a controller (PCBA) 160 installed to the enclosure base 120 of the control system assembly 100. As shown in FIG. 6, a ground wire 162 is a Y-shaped wire with a ground wire end 162a, a ground cable lug end 162b, and a loose wire end 162c. The ground wire end 162a couples to the neutral bar 122, which in turn is coupled to a ground that may be, for example, the lead water pipes of a dwelling. The ground cable lug end 162b couples to the metallic sensor module 144, which acts as the ground for the control system 100. The loose wire end 162c requires some detailed mentioning. The loose wire end 162c couples to the PCBA 160 through a metal terminal 164. The configuration ground wire 160 where the loose wire end 162c is connected to the PCBA 160 through the metal terminal 164, the ground cable lug end 162b is connected to the metallic sensor module 144, and the ground wire end 162a connected to an outside ground provides for the control system 100 to receive high current discharge (in the range of approximately 5000 A per UL testing) without burning up the control system 100 and safely discharging the current surge to the ground. Thus, the control system 100 is safely able to withstand a current surge in a manner that provides safety to the users of the spa system 2. As further shown in FIG. 18, a blower regulator 163 of the controller PCBA 160 is secured to the heatsink plate 121.

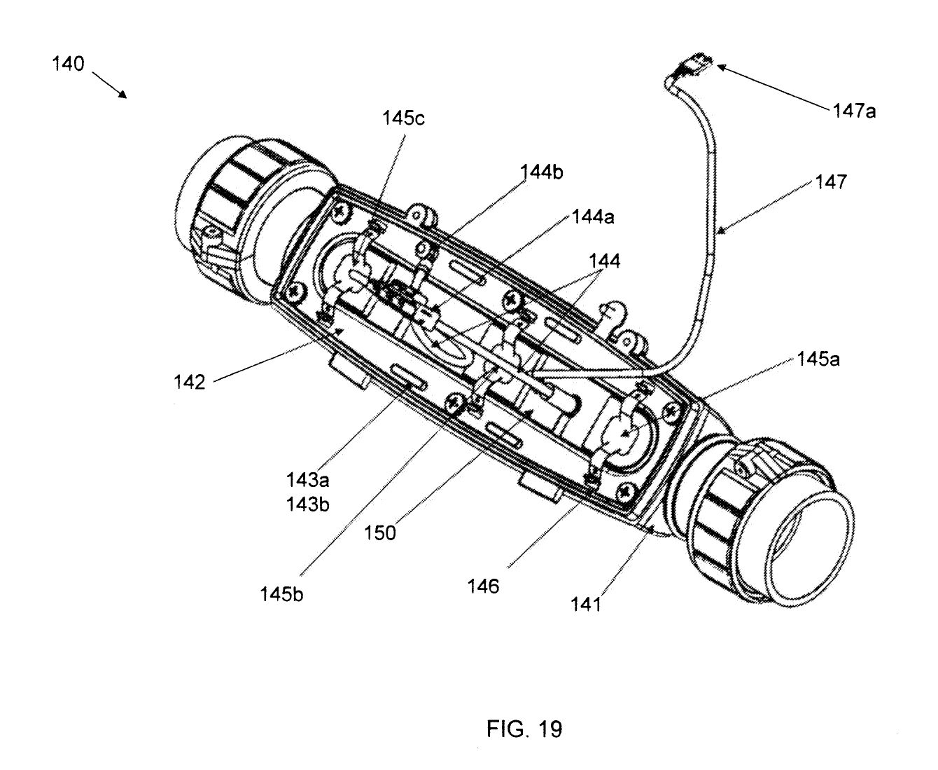

FIG. 19 illustrates an exemplary heater assembly 140. As shown in FIG. 19, the heater assembly 140 includes a water conduit 141. The water conduit 141 may have a trough-shape with an open top and be constructed of high performance plastic. The water conduit 141 also houses the heating element (not shown) that heats the water passing through the water conduit 141. The heater assembly 140 further includes a sensor module 142, which may be formed of metal as mentioned above. The sensor module 142 may include stabilizing holes 143a for accepting stabilizing notches 143b extending from the top of the heater 141. As the heating element heats the water passing through the conduit 141, temperature rises at the conduit 141. This causes the open end of the trough-shaped conduit 141 to expand outwardly, which may result in the conduit 141 leaking water inside the control system package 100 and damaging the control system 100. The stabilizing holes 143a protruding out of the metallic sensor module 142, restricts the conduit 141 from expanding outwards, and thereby provides structural integrity to the conduit 141. The sensor module 142 may be fastened to the water conduit 141 by using a number of fasteners as shown.

FIG. 18 further illustrates that heater housing 141 may have supporting ribs 141a for reinforcing the integrity of the heater housing 141 for reasons as described above. Also in this case, the heater housing 141 may be constructed of high performance plastic. FIG. 18 also illustrates the power connector 144a connected to the controller PCBA 160 and illustrates the sensor cable 147 having a second end 147b.

Further description of the sensor module 142 is now provided. A power cable 144 is connected to heating elements (not shown) positioned within the water conduit 141. The power cable 144 includes a power connector 144a for coupling to, for example, a power connection of the controller PCBA 160 and includes a ground stud 144b for connecting, for example, to the ground cable lug end 162b of the ground wire 162. The sensor module 142 includes a plurality of sensors 145a, 145b and 145c. Each sensor may be removably attached to the sensor module 142 via clips 146 at either side of the sensor. Although not shown, the sensors of the sensor assembly communicate with a sensor cable 147 having a end 147a for attaching to and communicating with the controller PCBA 160. The end 147a may be a 4 PIN connector.

It is worth mentioning that the sensor configuration as shown in FIG. 19 can provide for full temperature monitoring rather than just inlet and outlet temperature. For example, let's assume that sensor 145a measures the inlet water temperature, sensor 145b measures the water temperature in the middle of the water conduit, and sensor 145c measures the outlet water temperature. Various condition in the water conduit can be detected. For determining the temperature of the vessel water, the circulation jump is briefly started and the temperature sensors 145a, 145b, and 145c senses the water temperature. The water temperature is determined by taking the delta between the reading of sensor 145a and sensor 145b, and the delta between the reading of sensor 145b and sensor 145c.

To determined various conditions in the water conduit, the circulation pump may be activated briefly multiple times. During each start of the circulation pump, the temperature is measured by sensors 145a, 145b, and 145c. Suppose that each sensor shows that the temperature is going up with each start of the circulation pump and the heating element. This may indicate a critical failure because it may mean that there is no water in the water conduit and what is being heated is air in the water conduit. In this instance, the control system may alert the user through the control panel that service check is required. Suppose with each start of the circulation pump and the heating element, the sensors read that the temperature initially goes up but does not go down as much as expected subsequently. Also, the inlet side sensor 145a gives the same or similar reading and the outlet sensor 145c. This may indicate that the circulation pump has failed. The control system may alert the user through the control panel that service check is required. Suppose with each start of the circulation pump and the heating element, the sensors read that the temperature initially goes up and comes down as expected. Also, the inlet side sensor 145a gives a lower temperature reading than the outlet sensor 145c. This may indicate that the spa system is operating normally and no further action is required.

The above-described heater assembly 140 allows for easy removable and replacement of sensors 145a, 145b and 145c and removable of the sensor module 142 for access to heating elements and the interior of the water conduit 141. If necessary, the sensor module 142 including the heating element can be removed and can be easily replaced with a new sensor module 142 and heating elements. This task is performed by simply removing the fasteners, pulling out the old sensor module including the heating elements, replacing the old sensor module with a new sensor module, and fastening the new sensor module in place. This feature allows for easy serviceability of the control system 100 and provides for major advantages and benefits over conventional heater assemblies. As described above, the conventional heater assemblies have their temperature sensors and the heating element so integrated with the water conduit such that it is difficult to remove the sensors or the heating element without damaging the water conduit. Thus, if the technician is not careful, the technician could easily damage the seals preventing the water from leaking out of the water conduit and thereby, has to replace to complete control system.

FIG. 20 illustrates a step of assembling a heater assembly 140 to the control system 100. As shown the heater assembly 140 is positioned in the heater access openings 126 and attached to the retaining arms 125 of the enclosure base 120, such as by using a number of fasteners. The end 147a of the sensor cable 147 is connected to the controller PCBA 160. The ground cable lug 162a of the controller PCBA 160 is connected to the ground stud 144b of the heater sub-assembly 140.

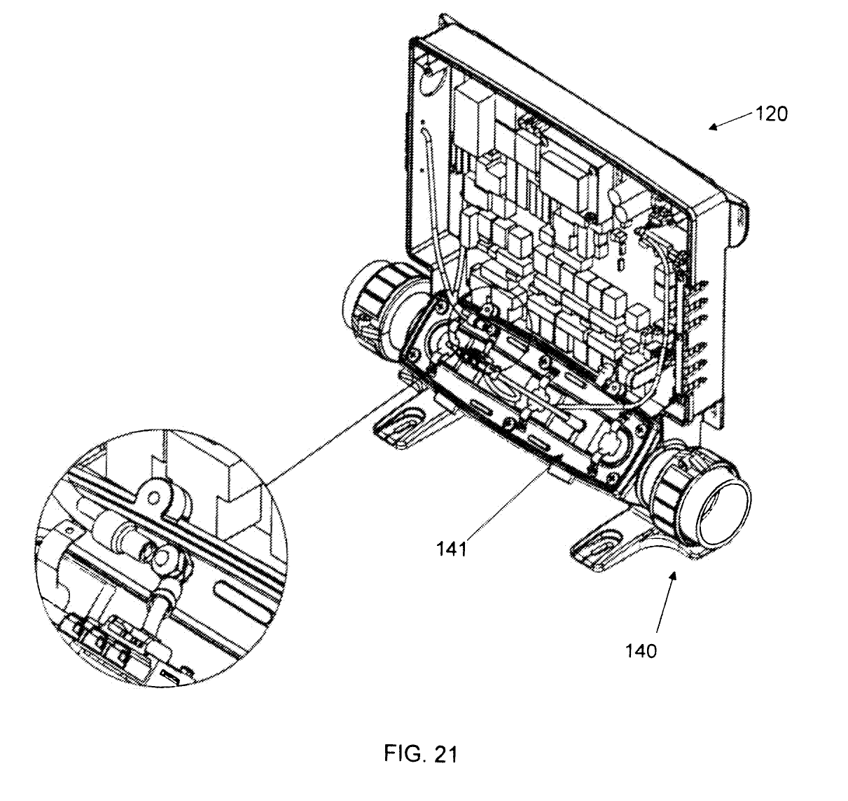

FIG. 21 illustrates a heater sub-assembly 140 assembled to the control system assembly 100. As shown, after assembly, the sensor plate 141 may be accessed or removed with necessitating removal of the heater sub-assembly 140 from the enclosure base 120. Also, the sensors may be removed and the various cables attached, removed, or replaced without necessitating removal of the heater sub-assembly 140 from the enclosure base 120.

The following will describe a method of controlling a spa system using a display panel according to an embodiment of the present invention.

A method of controlling the spa system includes operating a Shortcut Mode and a Navigation Mode.

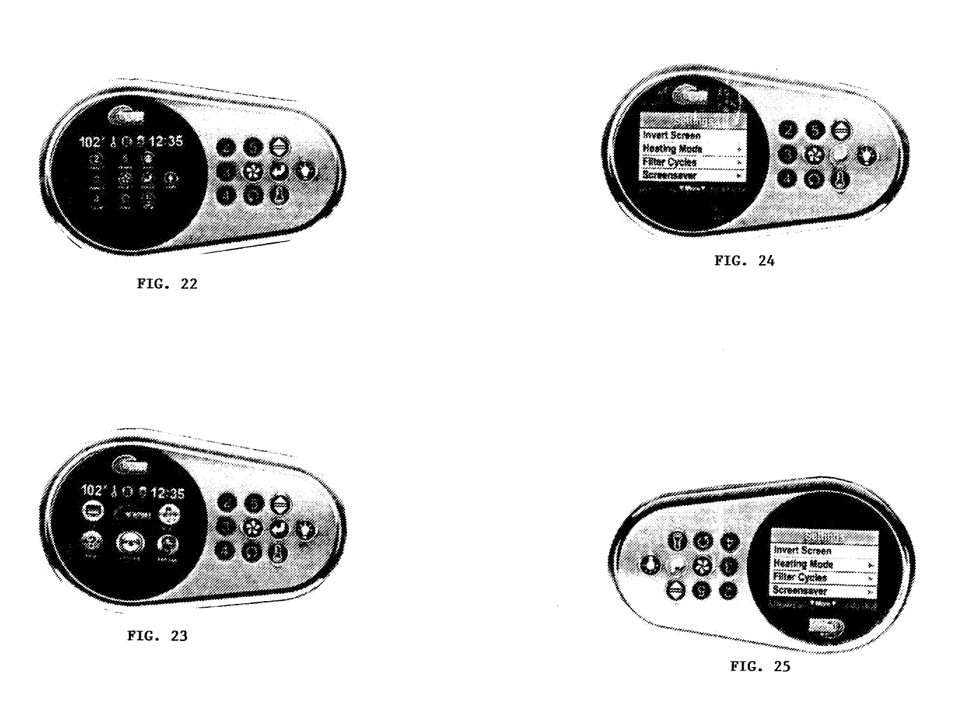

FIG. 22 illustrates a display panel in Shortcut Mode. In the Shortcut Mode, a single button touch turns a function on or off, like a pump, a blower, or a light, without any navigation or necessitating any additional steps. In the Shortcut Mode, the button functions are illustrated on the screen. In particular, shortcut button icons with button functions are displayed on the screen, and the buttons may be used to directly control the spa system equipment and other functions, such as first jets, second jets and/or third jets, the spa light, the water temperature, inverting the screen up-side-down, and the air blower. The icon on the screen may be highlighted, such as by displaying the icon as yellow, to indicate that the function is turned on. The Select button may switch the mode from Shortcut Mode to Navigation Mode. The Back button may be inactivated in the Shortcut Mode.

FIG. 23 illustrates a display panel in Navigation Mode. In the Navigation Mode, the full operational capability of the control panel is controlled. In the Navigation Mode, the options for controlling the display panel and spa system equipment are displayed on the screen as Icons. In the illustrated embodiment, the Jets Button is the move left navigation button, the Light Button is the move right navigation button, the Temperature Button is the move down navigation button and the Invert Button is the move up navigation button. After navigating to a desired choice, the Select Button is used to select a menu item or turn a menu item on or off. The Back Button is used to go back one level in the menu system. From the Navigation Home Screen shown in FIG. 24, the mode can be switched from the Navigation Mode to the Shortcut Mode by touching the Back Button or the mode may automatically switch if no buttons are touched for specified amount of time, such as 15 seconds.

As shown in FIG. 22, the Navigation Home Screen allows a user to select, for example, a TV Icon, a Help Icon, a Controls Icon, a Settings Icon and a Music Icon. Selecting an Icon will direct the user to a Menu corresponding to the selected icon.

After selecting the Setting Icon, the Settings Menu is entered, which is shown in FIG. 25. As shown the Settings Menu allows a user to select a plurality of menu options, including Invert Screen, Heating Mode, Filter Cycles and Screen Saving. The arrows at the right end of the menu bar indicate that that another sub-menu is available. The user may use the right button or select button to navigate to the next menu or the back button to return to the previous menu.

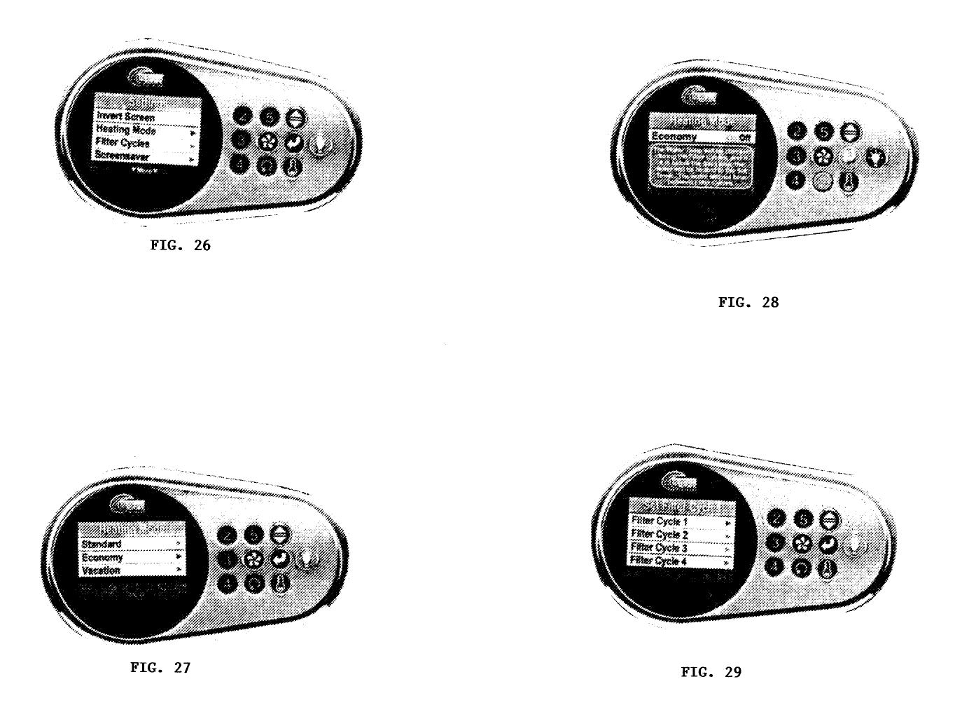

Selecting the Invert Screen will invert the screen, which is shown in FIG. 26. When the screen is inverted, the navigation buttons are also inverted, so the that the Up and Down buttons are switched with each other and the Left and Right buttons are switched with each other.

Selecting the Heating Mode Menu navigates to the Heating Mode menu shown in FIG. 27. The heating mode determines when the heater will heat and how the water temperature will be maintained. From the Heating Mode Menu, standard, economy and vacation may be selected. The default heating mode may be assigned as standard. To change heating modes, the Right button may be pushed to select Economy, for example, thereby moving to the Economy Menu of FIG. 28. To activate Economy heating mode, the Select button may be selected or the Back button may be selected to exit. In this menu a notice is displayed in blue indicating that the water temperature will be checked during the filter cycles, and if is below the set temperature, the water will be heated to the set temperature, but that the water will not be heated between filter cycles.

One aspect to maximize energy efficiency is to implement “smart polling.” With smart polling, the time interval between polling cycles is variable and is based on how much heat has been lost, if any, in the previous polling interval. In a conventional system, during polling, the temperature of the water is measured at every fixed time interval. Thus, if the fixed time interval is thirty minutes, the control system will poll the water temperature every thirty minutes. Polling is performed by first circulating the vessel water by starting the circulation pump. In this manner, the actual vessel water temperature can be measured. It may be that the vessel water need not be heated until several hours, yet under the conventional polling system, the control system will poll every thirty minutes. Under smart polling, if the current polling indicates that the vessel water need not be heated, the next polling may occur an hour later rather than thirty minutes later. An hour later, if the polling indicates that the vessel water need not be heated, the next polling may occur an hour and a half later. Thus, for a same time period, the smart polling will perform less polling than a conventional polling requiring less circulation pump start-ups, and resulting in less energy consumption.

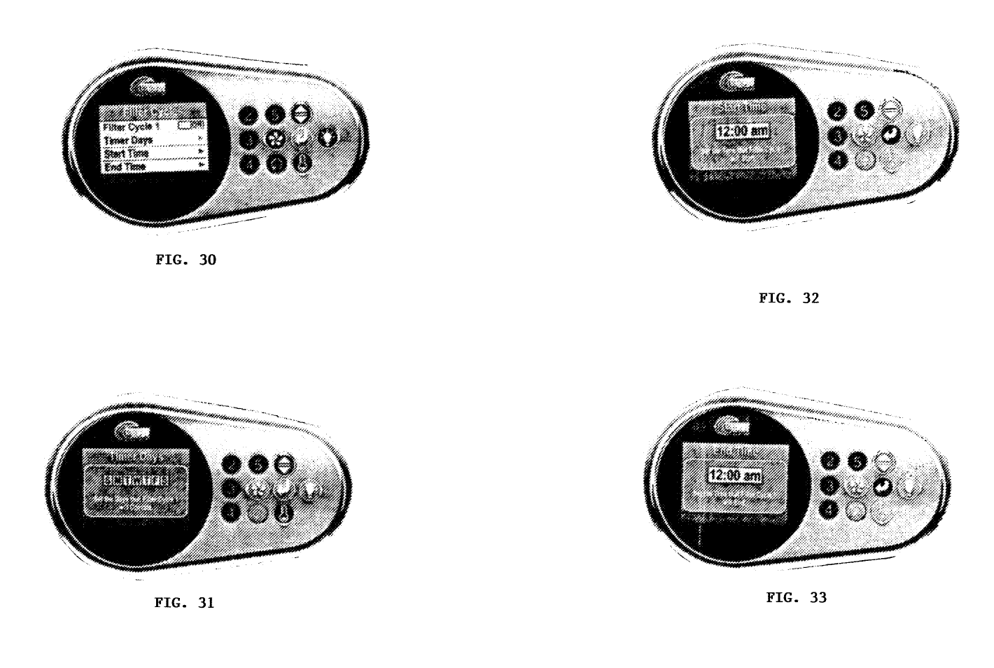

From the Setting Menu, filter cycles may be selected as shown in FIG. 29. From the Filter Cycles Menu, different filter cycles may be selected. From the Filter Cycle 1 Menu of FIG. 30, filter cycle 1 may be enabled or disabled. If the filter cycle is set to Off, the system ignores the settings for filter cycle 1. From the Filter Cycle 1 Menu, timer days, start time and end time may also be selected. The Timer Days Menu Bar of FIG. 31 allows the user to select the days that Filter Cycle 1 will operate. To turn a day on or off, the user may move left or right to that day and touch the Select Button. To exit, the user may select the Back Button. The Start Time Menu Bar of FIG. 32 allows the user to select the start time for the Filter Cycle 1. The End Time Menu Bar of FIG. 33 allows the user to select the end time for the Filter Cycle 1. Filter Cycles 2, 3 and 4 may be operated in a like manner.

Another energy saving measure is the “smart filter cycle” for energy efficiency. In a conventional system, the filter cycle will run independently for a fixed period of time regardless of the other cycles in order to clean the vessel water from particulates. In the smart filter cycle, however, the time that the circulation pump had turned-on accumulatively between filter cycles is deducted from the programmed filter cycle time. This is because every instance of the circulation pump being turned on causes the vessel water to filter through the filter. Thus, by deducting the accumulative time when the circulation pump had operated between filter cycles from the programmed filtered cycle, the same desired result can be achieved but with shortened filter cycle, and thereby conserving energy.

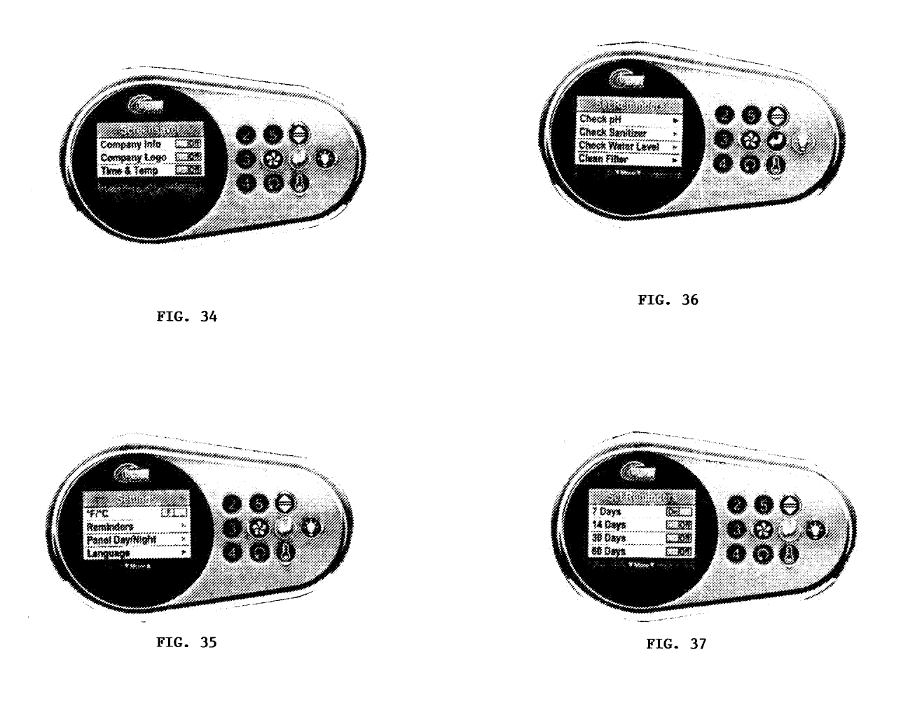

From the Setting Menu, the Screensaving Menu may be selected as shown in FIG. 34. The screensaver can be set to display, for example, company information, a company logo or the time and temperature. If the screensaver is turned on, the selected screensaver will replace the menu screen until a button is touched or until the display is turned off.

From the Setting Menu of FIG. 25, additional menu options may be displayed by navigating down to the bottom the menu. The additional menu options as shown in FIG. 35 may include selecting Fahrenheit or Celsius. Also shown in FIG. 35 is the reminders menu, which includes setting reminder messages to pop-up periodically to remind the user to perform normal maintenance, such as checking pH, checking Sanitizer, checking Water Level and cleaning the Filter, as shown in FIG. 36. The reminders may be set for 7 days, 14 days, 30 days or 60 days as shown in FIG. 37.

Also shown in FIG. 35 is the Panel Day/Night selection. In direct sunlight, it may be easier to read the screen with a white background rather than a black background. A user can set the display to Always Day Mode, Always Night Mode, or Automatic Day/Night Mode.

Additional features in the Settings Menu allows the use to set the default language, lock the control panel, lock the water temperature, setting the temperature over 104 degrees F, setting the time and date.

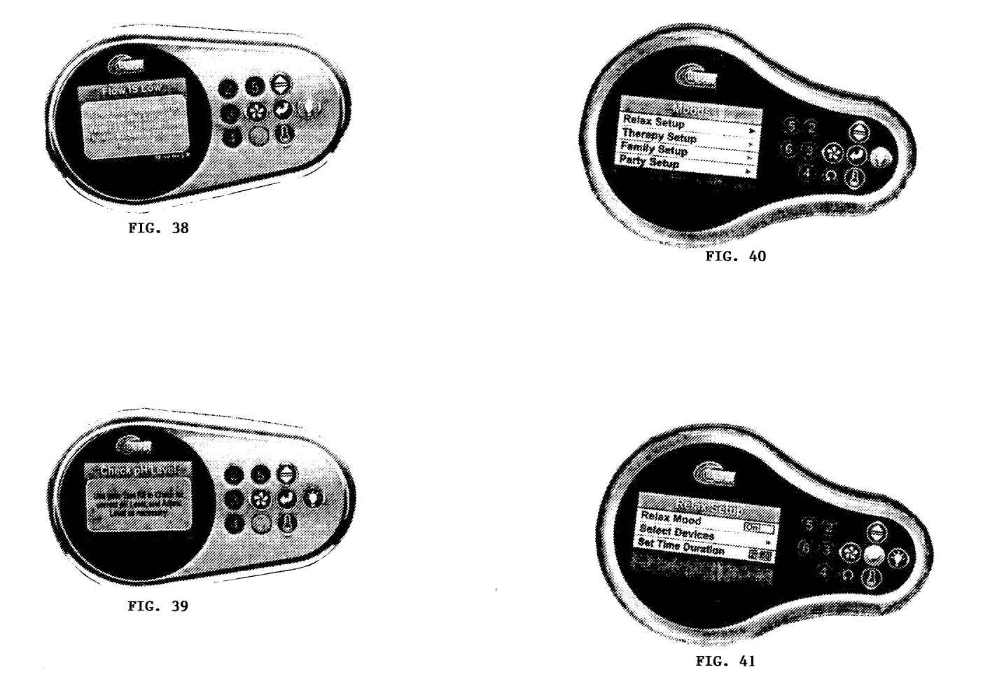

The spa system also offer help with various Pop-Up Messages a user may see and for days to day spa maintenance. The Help Menu is located on the Navigation Home Screen. The Help Menu offer user assistance with Messages, Maintenance, Troubleshooting and Hints & Tips. For help with messages, a Message Menu list a number of pop-up messages, which the user may select. When the message is selected, such as the Flow IS Low message, the Flow IS Low help pops up on the screen as shown in FIG. 38. In this case, the pop-up message is red, which indicates urgency or danger. For More Help, the select button may selected to display further message help on the topic.

For help within maintenance, a Maintenance Menu lists a number of maintenance topic, such as how to Check pH Level. When this topic selected, the Check pH Level help pops up on the screen as shown in FIG. 39. In this case, the pop-up message is green, which indicates lack of urgency or safety.

The spa system also offers the ability to select and modify Moods. Moods allow the user to select preset Pumps and Speed, Lights and Levels and which Device the user wants playing music in various moods. The Moods Icon may be selected from the Navigation Home Screen to enter the Moods Menu as shown in FIG. 40. From the Moods Menu, a mood type may be selected, such as Relax mood, Therapy mood, Family mood or Party mood. Selecting a mood enter the Mood Setup Menu as shown in FIG. 41. From Mood Setup Menu, the user may turn the Mood on or off, may select devices and set time duration. From the Select Devices Menu, the user may scroll through several pages of available devices and turn them on or off, set the pump and blower speeds, set the spa light level and set the music play for the selected mode.

The spa system also offers wellness timers available on the Timers Menu from the Navigation Home Page. There is a timer that starts at zero and counts up, three countdown timers that count down to zero, and an alarm that flashes the spa light at the set time, turns off all the pumps that are running, and/or turns off everything that is on except the spa light.

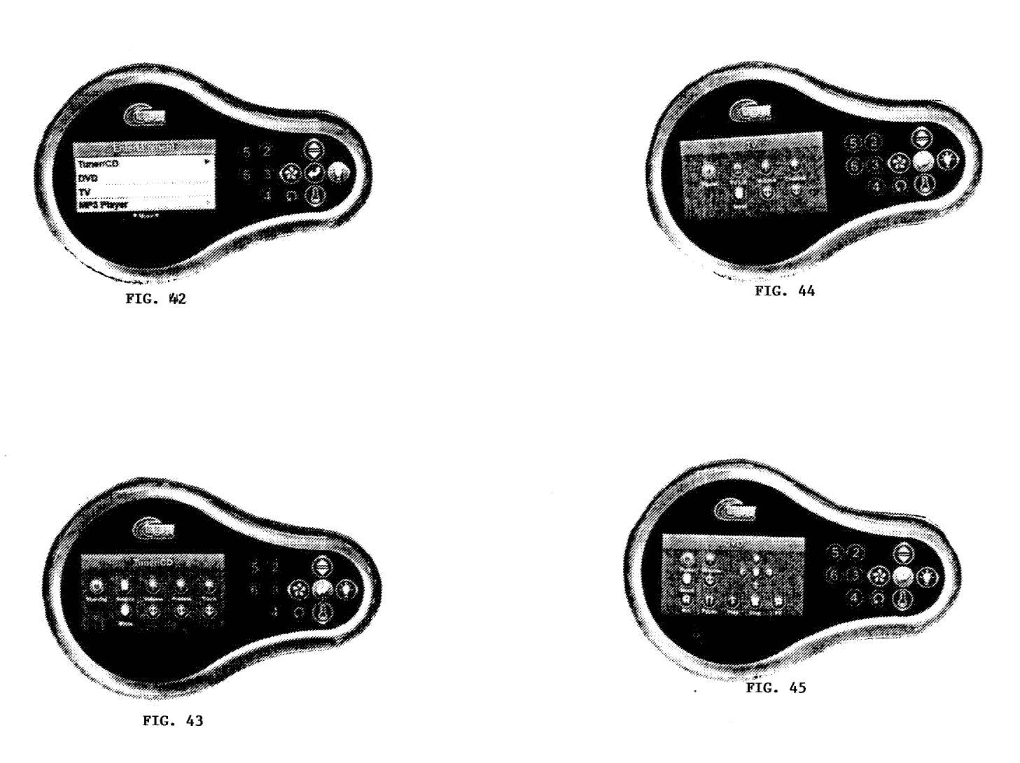

The spa system also offers control of entertainment and plays games. The Entertainment Menu found on the Navigation Home Page in shown in FIG. 42 and allows selection of Tuner/CD, DVD, TV, MP3 Player and more. The Tuner/CD Menu is shown in FIG. 43. To control the options on the Tuner/CD Control Menu, the user may navigate left, right, up and down to the desired option and then tough the select button to activate the desired option.

The TV Menu shown in FIG. 44 allows a user to control the TV and any TV options or functions. The Power icon on the TV Menu turns the TV on or off and the channels and volume icons change the channels and volume on the TV. The DVD Menu shown in FIG. 45 allows a user to control the DVD player and any DVD options from the DVD Menu.

The Games Menu may be entered from the Navigation Home Page. The Games Menu allows a user to play several different games on the display of the control panel using the navigation buttons.

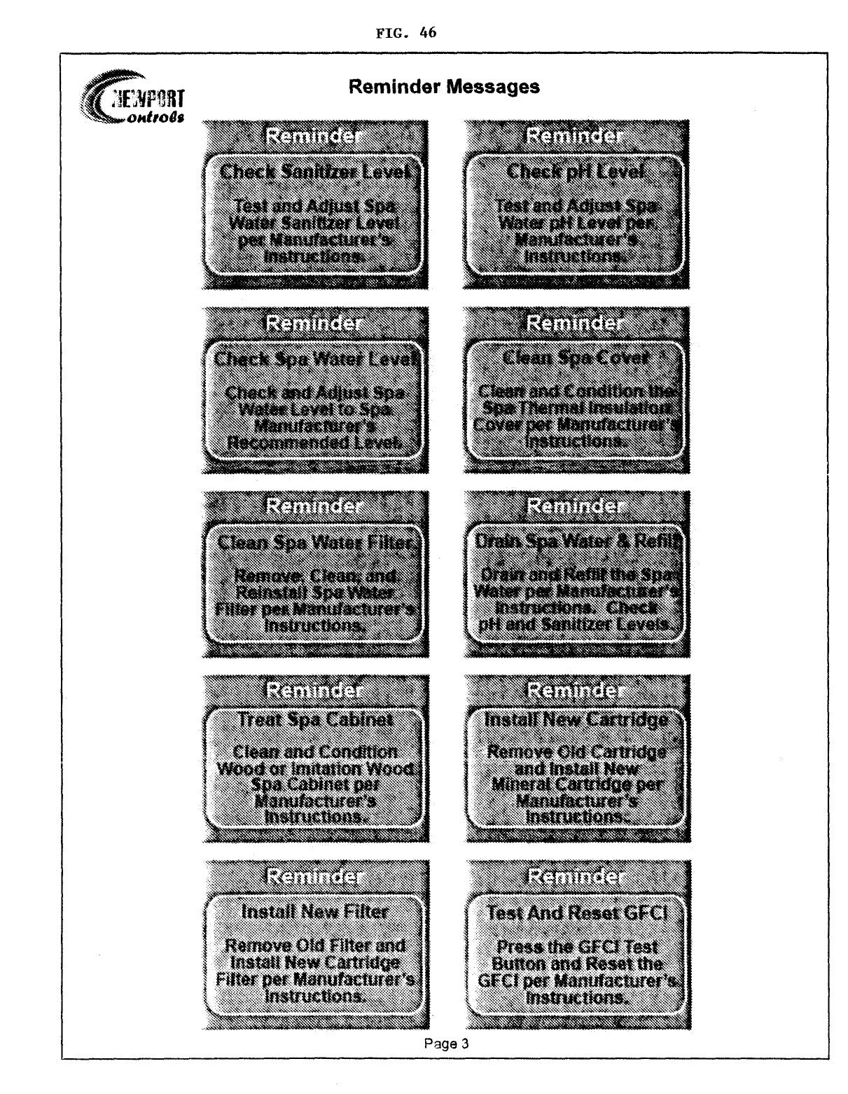

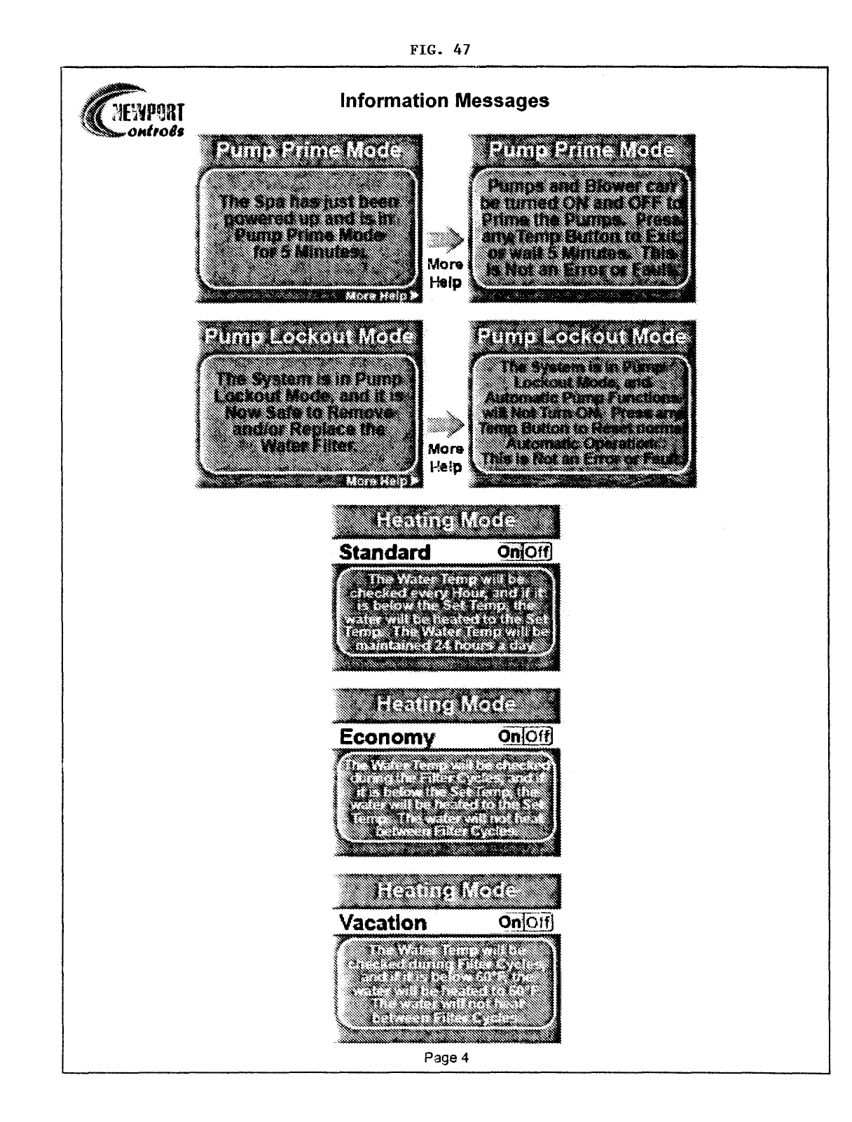

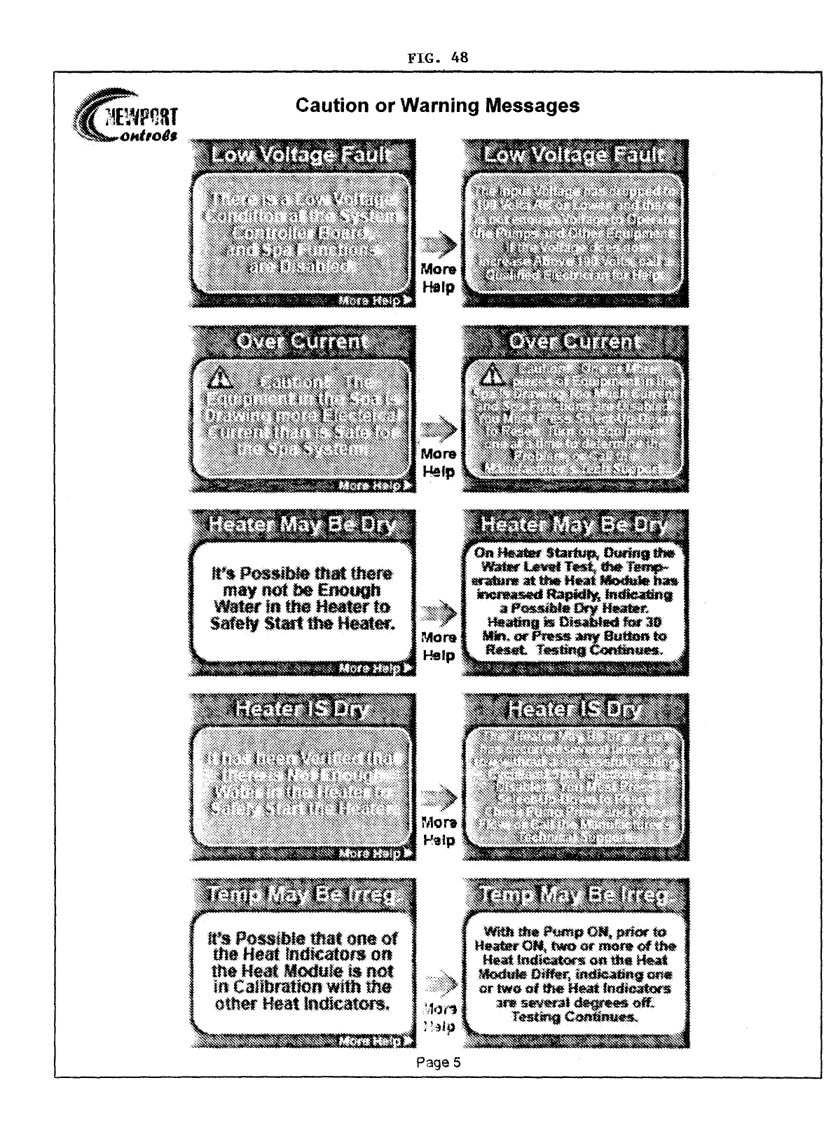

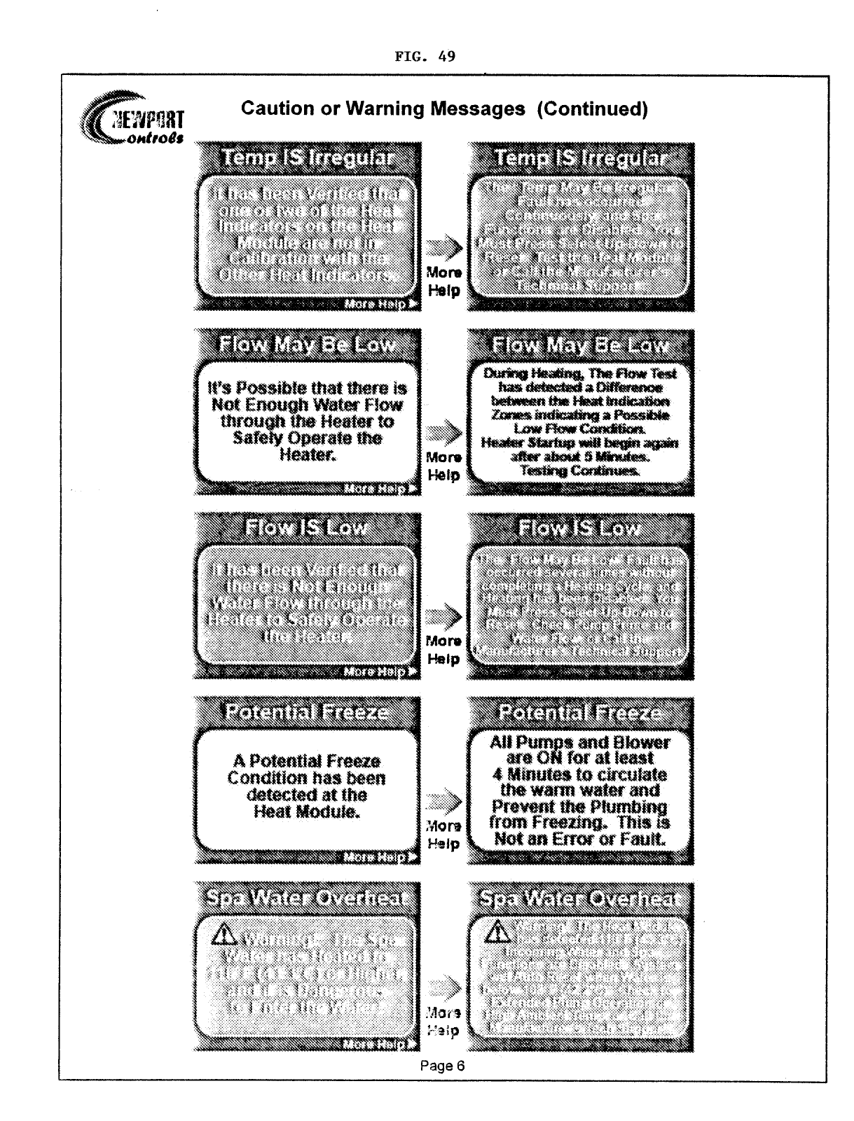

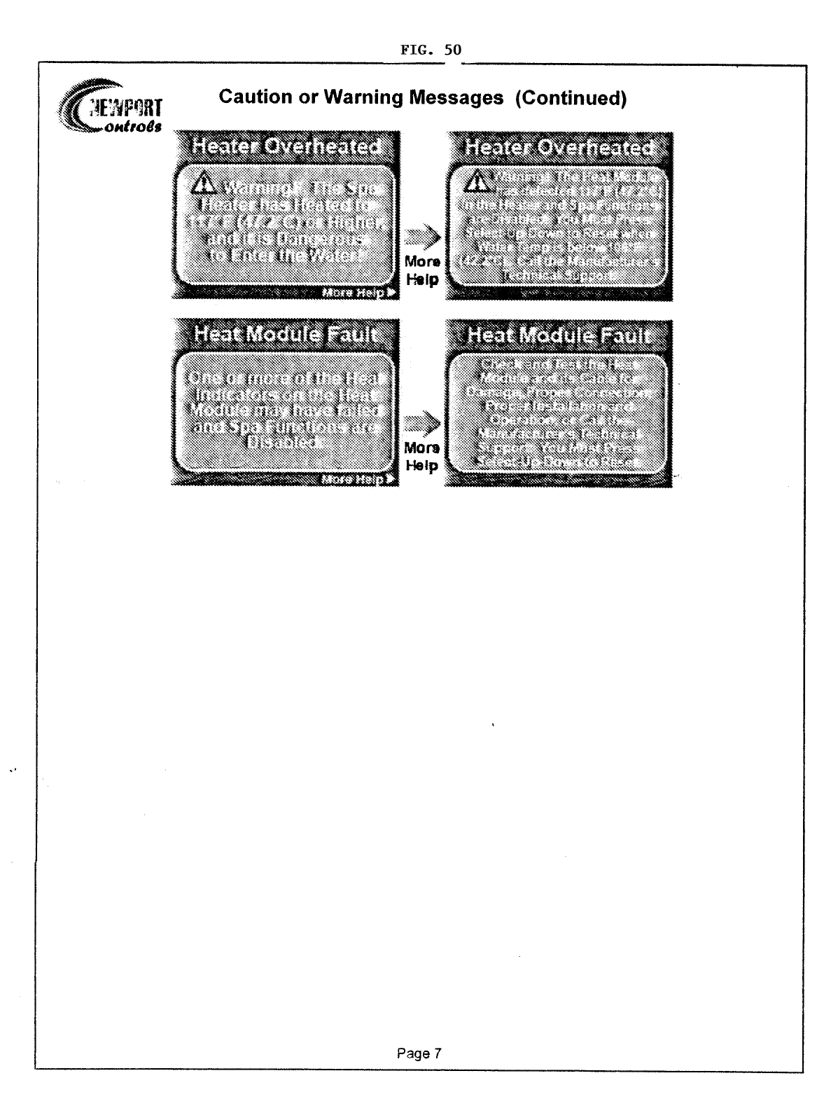

The spa system pops up reminder messages, information messages, and caution or warning messages. For example, FIG. 46 shows a variety of reminder messages shown in green, FIG. 47 shows a variety of information messages shown in green and blue and FIGS. 48-50 shown a variety of caution or warning messages shown in yellow and red, indicating respective levels of urgency.

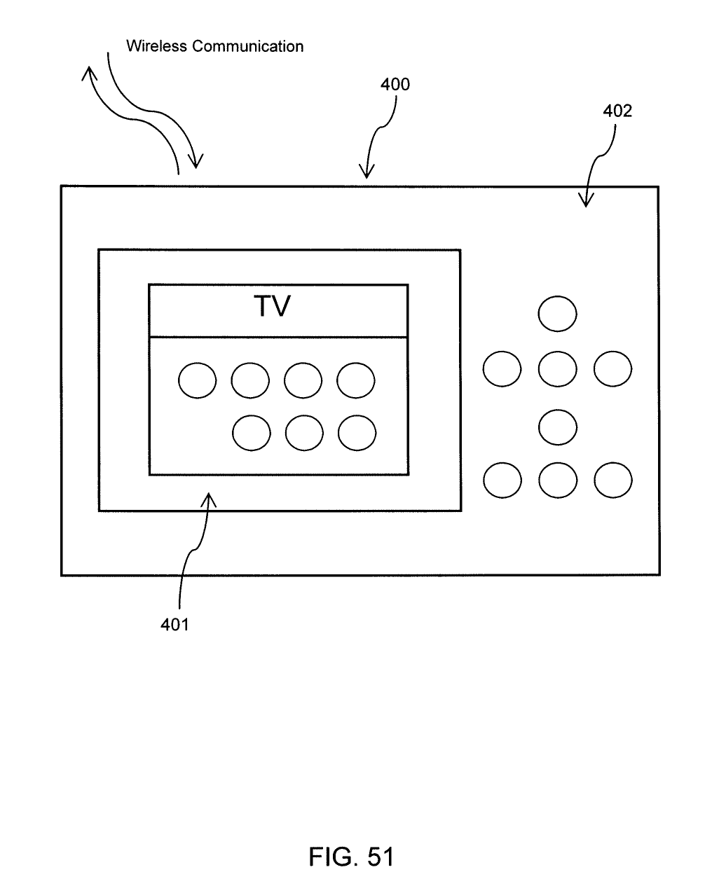

FIG. 51 illustrates another exemplary display panel 400 which may communicate using wired or wireless communication. The display panel 400 may include a larger display region 401 than the display region 201 of the display panel 200 previously described. As an example, the display region 401 may be a 7″ or a 12″ color liquid crystal display (LCD). One of the purposes of a larger display region is that the display panel 400 may be used to view video contents from a TV tuner, iPod, cellular phone, Blackberry™ device, and/or DVD player thereby providing for a spa entertainment/communication system that is available directly from the display panel 400. Selection and control of the TV tuner, iPod, cellular phone, Blackberry™ device, and DVD thereof may be done through a menu displayed at the display region 401 which is formed as a touch screen. In one embodiment, the display panel 400 is configured to receive video contents from a video source and display the video contents on the LCD of the display region 401 using known technology. Examples of the menus are described with reference to FIGS. 42-45 and will not be further described here.

An exemplary operation of the TV tuner will now be described. The user navigating through the menus come to the entertainment menu and selects the TV tuner. At the TV tuner menu the user can select the channel that the user wishes to view. Once the selection has been made, the menu disappears and the display region 401 is replaced with streaming video contents of the selected channel. By touching the display region 401 the user can cause the TV tuner menu to pop up to thereby make a different selection. Alternatively, the display panel 400 may be equipped with an interface region 402 having one or more switches such as capsense™ switches whose function changes with the selection made by the user. For example, if the user selects DVD from the entertainment menu, the switches are configured to provide the functions of STOP, PLAY, FORWARD, REVERSE, FAST FORWARD, and FAST REVERSE, SKIP, etc. Likewise, if the user selects TV tuner from the entertainment menu, the switches are configured to provide the functions of CHANNEL, NORMAL MODE, WIDE MODE, BRIGHTNESS, CONTRAST, etc.

Other features may be added to the display panel 400. For instance, the display panel 400 may include capabilities to access the Internet from the display panel 400. For instance the user may select internet from the entertainment menu which causes the display panel 400 to be connected to the Internet. Control of the webpages may be performed using the switches at the interface region 402, if available. Otherwise, one or more touch screen switches will be displayed at the display region 401. In one embodiment, implementation and control of the webpages using switches or the touch screen may be similar to those found in Playstation™ 3 from Sony® or X-box™ from Microsoft®.

Another feature that may be added is that the display panel 400 may be used to exchange text messages. The user may select text message from the entertainment/communication menu which causes the display panel 400 to be connected to the Internet or the wireless phone network. Operation of the text message will be similar to those performed using a cellular phone or email. In one embodiment, the display panel 400 may be equipped with Bluetooth that allows the display panel 400 to have a two-way communication with the user's cellular phone. In this manner, the display panel 400 may be provided with most if not all the features available at the user's cellular phone. In another embodiment, the display panel 400 may have a two-way communication with the user's Blackberry™ device using Bluetooth and thereby, is provided with the features of the Blackberry™ device.

While the user is entertained with the contents selected from the entertainment menu, should one or more failures occur in the spa system, for example, as shown in FIGS. 48-50, the materials of the entertainment/communication menu displayed at the display region 401 will be interrupted with a display message, for example, as shown in FIGS. 48-50 to make the user be aware of the situation regarding the spa system.

Additional information relating the navigational menu features of the display panel are described in the flow charts of Appendix A.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A control system adapted for spa, comprising:
a finite state machine;
a control panel including a display, wherein the display of the control panel displays graphic images from a video source based on an operation of the finite state machine.
